(19) United States
(12) Patent Application Publication
(10) Pub. No.: US 2017/0251655 A2
(43) Pub. Date: Sep. 7, 2017

(54) COMPOSITIONS AND METHODS FOR CAPTURING, KILLING OR REPELLING BED BUGS

(71) Applicant: OLFACTOR LABORATORIES, INC., Riverside, CA (US)

(72) Inventors: Ulises Frutos, Colton, CA (US); Samer Elkashef, Moreno Valley, CA (US); Michelle Ardella Brown, Hemet, CA (US)

(21) Appl. No.: 15/113,643

(22) PCT Filed: Jan. 29, 2015
(86) PCT No.: PCT/US2015/013488

§ 371 Date: Jul. 22, 2016

Related U.S. Application Data
(60) Provisional application No. 61/932,950, filed on Jan. 29, 2014.

(51) Int. Cl. A01M 1/10; A01M 1/02; A01N 35/02; A01N 31/16; A01N 31/08; A01N 43/38; A01N 43/60; A01N 43/08; A01N 37/02; A01N 31/04; A01N 27/00; A01N 65/22; A01N 31/06; A01N 37/34; A01N 37/06; A01N 35/04; A01M 1/14

(52) U.S. Cl. CPC A01M 1/103; A01M 1/14; A01M 1/02; A01N 35/02; A01N 31/16; A01N 31/08; A01N 43/38; A01N 43/60; A01N 43/08; A01N 37/02; A01N 31/04; A01N 27/00; A01N 65/22; A01N 31/06; A01N 37/34; A01N 37/06; A01N 35/04

(57) ABSTRACT

The present invention provides compounds and blends for killing and/or modifying the behavior of bed bugs, and the like, including, but not limited to, biocides, attractants and repellents. Also provided are traps and methods of trapping and/or modifying the behavior of bed bugs and the like.

### CROSS REFERENCE TO RELATED APPLICATIONS

This application is a 35 U.S.C. §371 U.S. National Stage Entry of International Application No. PCT/US2015/013488 filed Jan. 29, 2015, entitled COMPOSITIONS AND METHODS FOR CAPTURING, KILLING OR REPELLING BED BUGS, which claims the benefit of priority of U.S. Application No. 61/932,950 filed Jan. 29, 2014, the contents of each of which are each incorporated herein by reference in their entirety.

### FIELD OF THE INVENTION

The present invention relates to the field attractants and repellents as well as methods of trapping and/or altering the behavioral patterns of pests such as bed bugs and similar hematophageous pests.

### BACKGROUND OF THE INVENTION

Bed bugs of the genus Cimex (including, but not limited to Cimex lectularius and Cimex hemipterus) are pests that bite humans (as well as other animals), feeding on blood. Bed bugs that feed on human blood often live in or around human sleeping areas, especially in warmer dwellings. Bites from bed bugs are associated with a number of adverse effects on health including, but not limited to rash development, allergic reactions and psychological effects.

In recent years, bed bug cases have been on the rise in developed countries. According to the U.S. National Pest Association there was a 71% increase in reported bed bug infestations between 2000 and 2005 alone. One of the reasons that bed bugs have become such an epidemic is that many bed bug populations have become resistant to insecticides that have traditionally been used for control and newer insecticides, such as propoxur, have been deemed to be too dangerous for human use by the Environmental Protection Agency (EPA). Current eradication strategies for bed bugs are costly, time consuming and often require a professional for implementation. The most common of these strategies is heat treatment and fumigation of a residence which requires the inhabitants to evacuate the residence for a two day period. This technique often results in re-infestations as bed bugs can take shelter in cracks in the wall where the heat treatment cannot reach them.

Bed bug control is difficult due to their size and habits (US Patent Application No. US 2012/0285076.) Bed bugs are tiny insects, ranging from 1-7 mm long and have a flat body shape enabling them to hide in narrow spaces, such as cracks and crevices. They are also nocturnal, generally limiting their activity to between the hours of 10 pm and 6 am. Bed bugs have a lifespan ranging from several months to up to four years and may be able to go up to a year without a blood meal.

Many hematophageous insects, including, but not limited to bed bugs, are able to track vertebrate blood-meals through thermal and/or olfactory sensing. In some cases, olfactory sensing may include the detection of carbon dioxide (CO₂) emissions in exhaled breath (Anderson J. F. et al., 2009. Med Vet Entomol. 23(2):99-105; Gillies M. T., 1980. Bull. Entomology Res. 70:525-532).

With increasing awareness of the harmful effects of many chemical components of insecticides, there remains a need in the field to develop methods, compounds and compositions for controlling bed bug populations and behavior with minimal risk to humans and the environment. Many of the compounds and compositions described herein include a number of natural products as well as structurally similar synthetic molecules, potentially making these compounds less harmful to the environment and to human health. Thus, the devices, methods and compositions described herein represent a solution to address the long felt need for bed bug control.

### SUMMARY OF THE INVENTION

In some embodiments, the present invention provides a composition for attracting and/or repelling one or more pests to or from one or more sites. Such compositions may comprise one or more of the compounds BBC001-BBC086. In some cases, compositions of the invention attract bed bugs to one or more sites. Such compositions may comprise one or more compounds selected from the group consisting of BBC035, BBC039, BBC047, BBC060, BBC065, BBC069 and BBC070 or one or more blends selected from the group consisting of BBB028, BBB058, BBB072, BBB078, BBB080, BBB086, BBB102-BBB107 and BBB120. Such sites may include bed bug traps. Other compositions repel bed bugs from one or more sites. Such compositions may comprise one or more compounds selected from the group consisting of BBC001-BBC050 or one or more blends selected from the group consisting of BBB001-BBB089. In some cases, such compositions comprise synergistic blends of compounds, in some cases selected from the group consisting of BBB001, BBB027, BBB022, BBB029, BBB021, BBB005, BBB007, BBB020, BBB018, BBB004, BBB016, BBB006, BBB030, BBB032, BBB033, BBB039, BBB037, BBB038, BBB041, BBB040, BBB043, BBB046 and BBB047. Repellent compositions may repel bed bugs from one or more areas of habitation.

The present invention also provides methods of attracting and/or repelling pests from one or more sites. Such methods may include the use of compounds and/or compositions described herein.

In some embodiments, the present invention provides a bed bug trap comprising a trap frame (comprising a rim, base and trap wall,) a trap wall outer surface comprising a climbing surface, one or more optional trap windows, and an optional lure. In some cases, climbing surfaces may be textured. In some cases, climbing surfaces are contoured with a pattern of peaks and valleys. Some traps comprise peaks and valleys that are pointed, flat or comprise ridges. Some traps of the present invention comprise a circular cross sectional shape when viewed from above.

In some cases, traps of the present invention comprise climbing surfaces that comprise a percentage of the trap wall outer surface of from about 30% to about 90%. Such traps may comprise at least one window between the climbing surface and rim. In some cases, these traps comprise three windows. Trap frames may comprise materials selected from paper, plastic and styrofoam and may comprise varying thicknesses.

In some embodiments, the present invention provides a bed bug trap comprising: a trap frame comprising a rim, base and trap wall, a skirt layer comprising a climbing surface, and an optional lure. In some cases the skirt layer comprises a truncated cone shape. In other embodiments, the skirt layer starts in contact with said rim and tapers outward to form an angle between said skirt layer and said trap wall, wherein said angle is selected from the group consisting of from about 10° to about 50°. In some cases, the angle is about 30°.

In some embodiments, bed bug traps of the invention comprise a plug lid and/or a base peg. In some cases, plug lids comprise a base peg sleeve. A frictional force may exist between the base peg and the base peg sleeve. Some plug lids comprise an overhang above the rim.

In some embodiments, bed bug traps of the invention may comprise: a height of from about 0.5 inches to about 2.0 inches, a rim diameter of from about 1 inch to about 3 inches, and a base diameter of from about 1 inch to about 4 inches. In some cases, such bed bug traps comprise: a height of about 1.0 inch, a rim diameter of about 1.5 inches, and a base diameter of about 1.5 inches.

In some embodiments, bed bug traps of the invention may be comprised of a material selected from the group consisting of polyethylene, polypropylene and polyethylene terephthalate (PET). Bed bug trap materials may comprise a thickness of from about 0.001 inches to about 0.20 inches.

In some embodiments, bed bug traps of the invention comprise a lure comprising any of the compounds, blends and/or compositions of the invention. In some cases, such lures are part of a bait substrate.

Also provided are methods of capturing bed bugs comprising the use of any of the bed bug traps presented herein.

### BRIEF DESCRIPTION OF THE DRAWINGS

The foregoing and other objects, features and advantages will be apparent from the following description of particular embodiments of the invention, as illustrated in the accompanying drawings. The drawings are not necessarily to scale, emphasis instead being placed upon illustrating the principles of various embodiments of the invention.

FIG. 1 is a diagram of one embodiment of a trap of the present invention with a cup-like structure.

FIG. 2 is a diagram of one embodiment of a trap of the present invention with a cup-like structure and windows.

FIG. 3 is a diagram of one embodiment of a trap of the present invention with a cup-like structure, windows and a climbing surface.

FIG. 4 is a diagram of one embodiment of a trap of the present invention with a cup-like structure, windows and a climbing surface.

FIG. 5 is a diagram showing bottom and side views of the trap depicted in FIG. 4.

FIG. 6 is a diagram showing bottom and side views of the trap depicted in FIG. 4.

FIG. 7 is a diagram of one embodiment of a trap of the present invention with a cup-like structure, windows and a climbing surface.

FIG. 8 is a diagram showing a side view of a low profile trap.

FIG. 9 is a diagram showing a side view of a low profile trap.

FIG. 10 is a diagram showing a side view of a low profile trap with plug lid.

FIG. 11 is a diagram showing a cross-sectional side view of a skirted trap.

FIG. 12 is a diagram showing a cross-sectional side view of a skirted trap with plug lid and bait substrate.

FIG. 13 is a diagram showing a cross-sectional side view of one embodiment of a skirted trap.

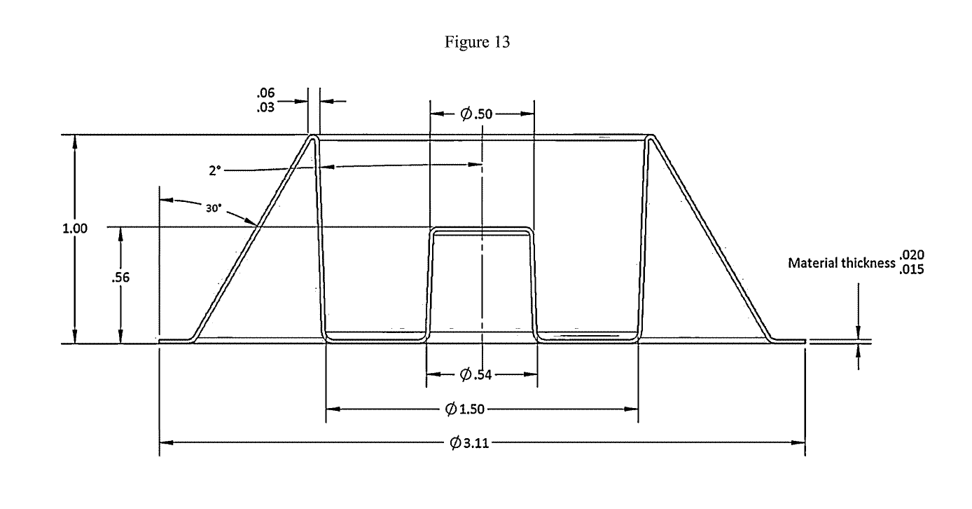

FIG. 14 is a diagram showing a cross-sectional side view of one embodiment of a plug lid.

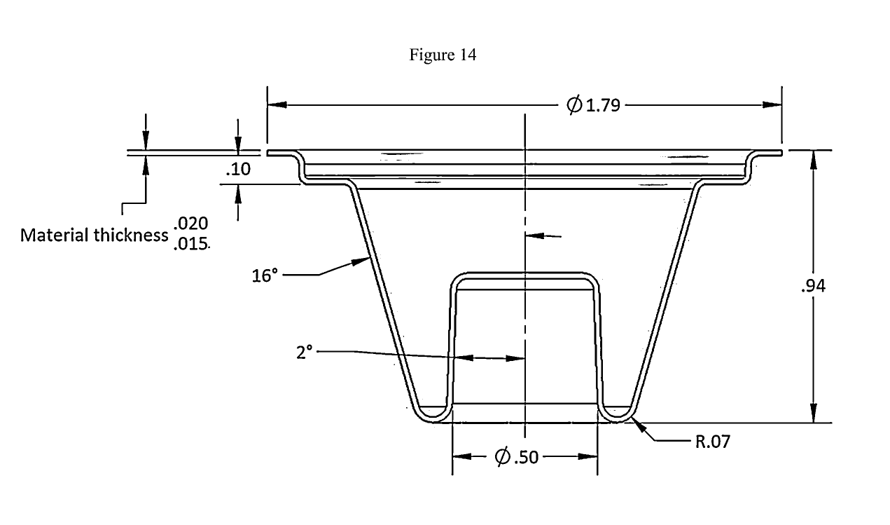

FIG. 15 is a diagram showing a cross-sectional side view of one embodiment of a skirted trap with plug lid.

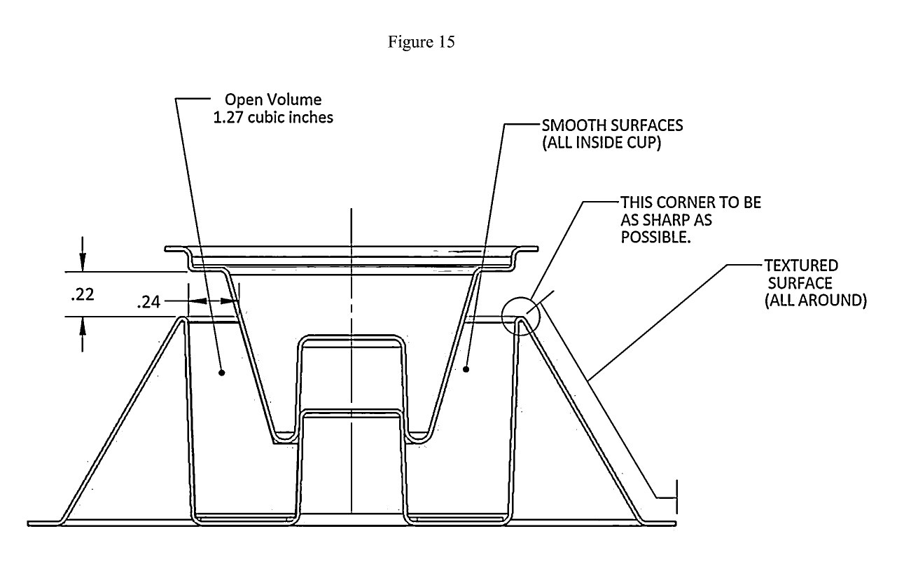

FIG. 16 is a diagram showing a cross-sectional side view of one embodiment of a skirted trap with plug lid.

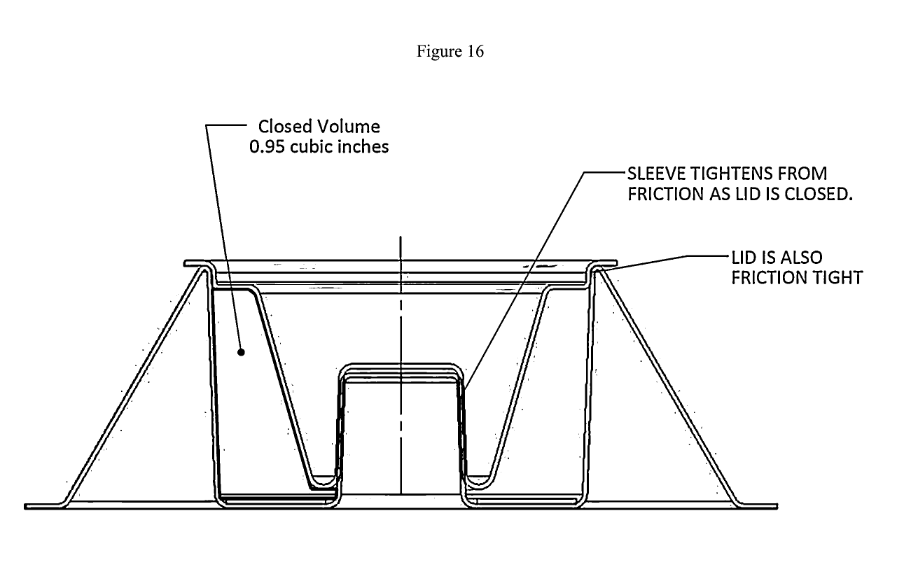

### DETAILED DESCRIPTION OF THE INVENTION

In recent years there has been a massive spike in the number of reported bed bug infestations in the United States, with all 50 States reporting infestations and Cimex lectularius being the main culprit (Hengge, U. R. 2009. Clin Dermatol. 27(3):285-90.) According to the National Pest Management Association there has been a 71% increase in the number of reported bed bug infestations between 2003 and 2005 alone and in 2012 there was a 33% increase of bug bed infestations over 2011. Since bed bugs can mate incestuously the introduction of one egg laying female into a residence is enough to start an infestation. Bed bugs are obligate blood-feeders and the majority feed on human blood but will feed on other prey if humans are not available (Harlan, H. J. 2006. American Entomologist. 52(2):99-101.) They are nocturnal creatures feeding on the exposed skin of the sleeping host. A bed bug uses it's rostrum to pierce the skin of its host and will typically take 5 to 10 minutes to become fully engorged with blood (Lance, A. et al., 2009. Medical and Veterinary Entomology, Second Edition. Academic Press. p. 80). While these bites do not spread disease, they are very painful and can result in adverse health effects including general urticaria, angioedema, intense pruritus and psychological distress, up to and including suicide (Thomas, I. et al., 2004. International Journal of Dermatology. 43(6):430-3.) In extreme cases individuals have bullous allergic hypersensitivity to the bites and/or developed anemia when exposed to a high abundance of bites. Bed bug infestations can also trigger anaphylactic asthmatic reactions in some individuals.

It is estimated that a typical single family dwelling infested with bed bugs costs $5,000 dollars on average to treat while infestations in large apartment complexes can cost upwards of $80,000 to treat. The typical treatment is a high heat treatment where the temperature in the dwelling is raised up to or above 113° F. for a sustained period of time (Doggett, S. L. et al., 2009. Aust Fam Physician. 38(11):880-4.) The problem with high heat treatment is that bed bugs can hide in cracks and crevices in the home where the temperature is cooler which can lead to re-infestation post treatment. Another common method used to control bed bug populations is through the use of pesticides. However it's been found that bed bugs have developed resistance to various pesticides including dichlorodiphenyltrichloroethane (DDT) and organophosphates (Steelman, D. C. et al., 2008. Journal of Agricultural and Urban Entomology. 25(1):45-51.) In Romero et. al, the authors found that the LD₅₀ for DDT for a population of C. lectularius isolated in Arkansas was 100,000 ppm (Romero, A. et al., 2007. Journal of Medical Entomology. 44(2):175-8.) Another study performed in Africa demonstrated that DDT treatment caused bed bugs to have a higher activity level (Steelman, D. C. et al., 2008. Journal of Agricultural and Urban Entomology. 25(1):45-51.) More importantly, some bed bug populations have also developed resistance to pyrethroids, one of the most common and effective pesticides available on the market today (Romero, A. et al., 2007. Journal of Medical Entomology. 44(2):175-8.) Recent studies using bed bug populations isolated from around the United States demonstrated that pyrethroid resistance is three orders of magnitude greater in wild populations than in laboratory strains and specifically that deltamethrin resistance was on the rise in major metropolitan areas such as New York (Yoon, K. S. et al., 2008. Journal of Medical Entomology. 45(6):1092-101.)

While heat and some chemical cues, such as lactic acid, have been shown to lure bed bugs, carbon dioxide (CO₂) emissions in exhaled breath are thought to be a major luring agent that draws bed bugs to humans (Annnderson, J. F. et al., 2009. Medical and Veterinary Entomology. 23(2):99-105; Singh, N. et al., 2012. Psyche. doi: 10.1155/2012/273613 and Wang, C. et al., 2009. Journal of Economic Entomology. 102(4):1580-5.) Like other hematophagous insects such as mosquitoes and sand flies, bed bugs detect CO₂ through their olfactory system and once detected they will travel up the concentration gradient towards a host to take a blood meal, traveling up to 1.5 m away from their harborage to do so (Harraca, V. et al., 2010. Chemical Senses. 35:195.) Previous studies performed in mosquitoes have shown that compounds other than CO₂ can interact with the CO₂ receptor and either activate or inhibit its activity (International Patent Application number PCT/US13/55330, the contents of each of which are herein incorporated by reference in their entirety.) Furthermore, such studies demonstrated that some compounds can mask the presence of CO₂ or repel mosquitoes from a CO₂ source, preventing female mosquitoes from finding a host and taking a blood meal.

Described herein are compositions and methods for the design, preparation and/or manufacture of compounds and devices which capture, kill and/or alter the behavior of bed bugs in a manner that is beneficial to animals, particularly humans. Included are traps that may be used in combination with any of the compounds, compositions and/or methods disclosed. As used herein, the term “bed bug” refers to host blood-feeding species that may inhabit areas in close proximity to host resting areas. Bed bugs of the genus Cimex (including, but not limited to Cimex lectularius and Cimex hemipterus) are pests that bite humans (as well as other animals), feeding on blood. As used herein, a “pest” refers to any one of a number of species that cause harm, irritation, discomfort or general annoyance to humans or other animals. Bed bugs that feed on human blood often live in or around human resting areas, especially in warmer dwellings.

Bites from bed bugs are associated with a number of adverse effects on health including, but not limited to rash development, allergic reactions and psychological effects. Some methods, compounds and/or compositions of the present invention may be used to repel bed bugs from a given subject, region or habitat. Other methods, compounds and/or compositions disclosed herein may be used to attract bed bugs from a given subject, region or habitat. Still further embodiments are described for the capturing and killing of bed bugs.

### Attractants and Repellents

Modification of bed bug behavior may be achieved through exposing bed bugs to compounds and/or compositions of the present invention in multiple forms. As used herein, the term “exposing” refers to applying a compound and/or composition to an object, surface, area, or region in such a manner and in sufficient proximity to bed bugs as to allow the sensing of the compound or composition by the bed bugs. Compounds and/or compositions disclosed herein may act as repellents and/or attractants depending on the method of use and/or concentrations. As used herein, an “attractant” is any compound and/or composition capable of attracting one or more pests, whereas a “repellent” is any compound and/or composition capable of repelling or deterring one or more pests.

In some embodiments, the present invention provides compositions for attracting and/or repelling pests to or from one or more sites. As used herein, a “site” refers to a specific location in space. Sites may include, but are not limited to flat surfaces, three dimensional areas, areas of habitation (including, but not limited to areas of human habitation,) bed rooms, traps (e.g. bed bug traps) and harborages. As used herein, the term “area of habitation” refers to an area, such as a dwelling where one or more subjects live or frequent. As used herein, the term “harborage” refers to a shelter or place of refuge. In the case of bed bugs, harborages may include a variety of locations in and around bedding areas. Such harborages may include, but are not limited to mattresses, box springs, pillows, pillow cases, cracks, crevices, behind wallpaper flaps, behind outlet covers, behind wall hangings, etc. In some cases, attractants may be applied to a site distant from a given subject or site of subject habitation to attract bed bugs away from such sites. According to other methods, attractants may be used to lure bed bugs to a trap. As used herein, a “bait” or “lure” is any compound and/or composition, object or chemically treated object capable of attracting one or more bed bugs to a trap. Further methods may use attractants that are toxic to bed bugs either through consumption or exposure. In some cases, modification of bed bug behavior may occur through the use of repellent compounds and/or blends. Repellents may be used to repel one or more pests from one or more sites. In the case of bed bugs, repellents may be used to repel bed bugs from human beings or their habitats. According to some methods disclosed herein, bed bug exposure to compounds and/or compositions may be carried out at levels that saturate bed bug olfaction ultimately resulting in a masking of that sense. Consequently, compounds that may be detectable to bed bugs by olfaction may also become repellents at saturating levels of exposure. As used herein, “masking” refers to the prevention of the sensing of one or more compounds by a subject when that subject is exposed to a given agent.

Regardless of directionality, the objective of embodiments of the present invention comprises the provision of compounds and/or compositions which ameliorate, reduce, or eliminate the deleterious effects on human (or other subject) health (including, but not limited to rash development, allergic reactions and psychological effects) caused by bed bugs. As such, the compounds and/or compositions of the present invention may be useful for the prevention of bed bug-related health issues in individuals, groups of individuals or large populations as well as the spread of such health issues.

In some cases, compounds of the present invention may comprise flavoring and/or fragrance agents. As used herein, the term “flavoring agent” refers to any agent that may elicit a particular taste in a subject that is exposed to such an agent or an agent that may be used to impart a particular taste to a composition to which it is added. Some flavoring agents may include any of those approved for human consumption by the Food and Drug Administration (FDA.) The term “fragrance agent,” as used herein, refers to any agent that may comprise a particular scent as perceived by a subject that is exposed to such an agent. Some fragrance agents of the present invention may include any that have been approved by the International Fragrance Association (IFRA.) In some cases, flavoring and/or fragrance agents may comprise known safety profiles and/or have been subjected to abundant toxicity studies.

In some aspects, methods according to the present invention have been developed to provide rapid screening of compounds for repellent and/or attractant behavior in bed bugs. Such methods may be used to identify compounds and blends that can be used to create and/or commercialize compounds and/or compositions for effective bed bug control.

### Bed Bug and Related Species

In some embodiments, bed bugs may comprise members of the order Hemiptera, including, but not limited to bed bugs of the genus Cimex (including, but not limited to Cimex lectularius, Cimex hemipterus, Cimex rotundatus, Cimex pipistrelli, Cimex pilosellus and Cimex adjunctus) and assassin bugs of the subfamily Triatominae (including, but not limited to members of the genus Melanolestes, Platymeris, Pselliopus, Rasahus, Reduvius, Sinea, Triatoma and Zelus.) Other bed bug species may include any of those listed in the World Health Organization publication Public Health Significance of Urban Pests by Bonnefoy X. et al., 2008; the contents of which are herein incorporated by reference in their entirety. Some bed bugs may comprise the “Earl” strain of bed bug, a pyrethroid-susceptible field strain collected in 2007 (Donahue, W. A. et al., 2013. Presentation from the Nebraska Urban Pest Management Conference, Sierra Research Laboratories.) In some cases, bed bugs may comprise the “Stockton 2” strain, a highly pyrethroid-resistant field strain.

In some cases, methods and compounds and/or compositions of the present invention may be used to control other hematophagous pests. Such pests may include, fleas of the order Siphonaptera [including, but not limited to members of the genus Ctenocephalides (including, but not limited to Ctenocephalides felis and Ctenocephalides canis), Pulex (including, but not limited to Pulex irritans), Dasypsyllus, Nosopsyllus and Xenopsylla.] Other such pests may include those of the order Ixodida which may include, but are not limited to ticks of the family Nuttalliellidae (including Nuttalliella namaqua), Ixodidae (including, but not limited to Ixodes scapularis, Ixodes holocyclus, Ixodes hexagonus, Ixodes pacificus, Ixodes ricinus and Ixodes uriae) and Argasidae. Further pests may include lice of the order Phthiraptera which may include, but are not limited to members of the genus Pediculus (including, but not limited to Pediculus humanus capitis and Pediculus humanus humanus) and members of the genus Pthirus (including, but not limited to Pthirus pubis). Pests which are of the order Diptera, including flying dipterans (the term “flying dipterans” as used herein refers to any members of the order Diptera that are capable of flight) may include, but are not limited to, members of the mosquito family Culicidae (including, but not limited to members of the genus Aedeomyia, members of the genus Aedes (including, but not limited to Aedes aegypti), members of the genus Anopheles (including, but not limited to Anopheles gambiae and Anopheles annulipes), members of the genus Armigeres, members of the genus Ayurakitia, members of the genus Bironella, members of the genus Borichinda, members of the genus Chagasia, members of the genus Coquillettidia, members of the genus Culex (including, but not limited to Culex quinquefasciatus, Culex molestus, Culex annulirostris and Culex australicus), members of the genus Culiseta, members of the genus Deinocerites, members of the genus Eretmapodites, members of the genus Ficalbia, members of the genus Galindomyia, members of the genus Haemagogus, members of the genus Heizmannia, members of the genus Hodgesia, members of the genus Isostomyia, members of the genus Johnbelkinia, members of the genus Kimia, members of the genus Limatus, members of the genus Lutzia, members of the genus Malaya, members of the genus Mansonia, members of the genus Maorigoeldia, members of the genus Mimomyia, members of the genus Onirion, members of the genus Opifex, members of the genus Orthopodomyia, members of the genus Psorophora, members of the genus Runchomyia, members of the genus Sabethes, members of the genus Shannoniana, members of the genus Topomyia, members of the genus Toxorhynchites, members of the genus Trichoprosopon, members of the genus Tripteroides, members of the genus Udaya, members of the genus Uranotaenia, members of the genus Verrallina, members of the genus Wyeomyia and members of the genus Zeugnomyia), Tsetse flies of the genus Glossina (including, but not limited to Glossina austeni, Glossina morsitans, Glossina pallidipes, Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to members of the genus Culicoides (including, but not limited to Culicoides sonorensis), members of the genus Leptoconops (including, but not limited to Leptoconops albiventris and Leptoconops torrens) and members of the genus Forcipomyia), black flies of the family Simuliidae (including, but not limited to members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to members of the genus Lutzomyia (including, but not limited to Lutzomyia longipalpis) and members of the genus Phlebotomus (including, but not limited to Phlebotomus papatasi)).

### Sensory Targeting

Exposure of bed bugs to attractant and/or repellent compounds and/or compositions of the present invention may induce one or more behavioral modifications. As used herein, the term “behavioral modification” refers to one or more adjustments or alterations to one or more pest behaviors. Such behaviors may include pest movement including to or from one or more compounds and/or compositions disclosed herein. Additional behaviors may include, but are not limited to pest feeding, breeding, flying, crawling, communicating and the like.

In some embodiments, one or more compounds and/or compositions of the present invention may modify behavior by targeting one or more senses of bed bugs. Such senses may include, but are not limited to olfaction (smell,) taste, touch, sight and hearing. In some cases, senses may include the ability of bed bugs to sense the presence and/or level of one or more molecules within a given area. In some cases, senses may be affected at the level of cellular receptor signaling. In some embodiments, compounds and/or compositions of the present invention may modulate receptor signal transduction necessary for one or more bed bug senses. As used herein, the term “sensory response” refers to any activity, including, but not limited to cellular and/or behavioral activity that occurs upon stimulation of one or more senses.

As used herein, an “activator” is any compound, composition or combination capable of activating a sensory response. Activators may modify pest behavior in varying ways and as such may act as attractants or inhibitors depending on the application.

As used herein, an “inhibitor” is any compound and/or composition capable of reducing a sensory response Inhibitors may modify pest behavior in varying ways and as such may act as pest attractants or repellents depending on the application.

Some compounds of the inventions, when combined produce synergistic outcomes with regard to their ability to kill and/or modify pest behavior. Such blends are herein referred to as “synergistic blends.”

### Carbon Dioxide (CO₂) Sensory Targeting

The two primary host-seeking mechanisms for bed bugs are carbon dioxide detection and skin odor detection. In some embodiments, the present invention provides compounds and compositions useful to activate, saturate and/or inhibit the activity of CO₂-responsive and/or skin odor-responsive neurons. CO₂-responsive receptors present on such neurons are generally conserved across different species of pests and are expressed by neurons in the antennae and/or maxillary palp. As used herein, a “CO₂ receptor” is a receptor or other cellular protein capable of sensing, binding or otherwise responding to CO₂ or to changes in CO₂ levels. A “CO₂-responsive neuron” is a neuron capable of directly sensing CO₂ or responding to changes in CO₂ levels and in which activity correlates with those levels. In some cases, such activity leads to modification of pest behavior. Internal studies have demonstrated that the CO₂-responsive neuron is also capable of skin odor detection. These studies have been confirmed by others (Tauxe, G. M. et al., 2013. Cell. 155:1365-79.)

As used herein, “neuronal activity” refers to cellular impulses that occur in one or more neurons. In some cases, neuronal activity may be detected using electrophysiological methods.

In some embodiments, the compounds and/or compositions disclosed may be activators of CO₂-responsive/skin odor responsive neurons. Some compounds and/or compositions of the present invention may be inhibitors of CO₂-responsive/skin odor responsive neurons.

Biocidal and/or Lethal Compounds

Some compositions of the present invention may comprise biocidal agents, also referred to herein as “biocides.” As used herein, the term “biocidal agent” or “biocide” refers to any agent capable of inducing biocidal activity such as retarding growth, retarding reproduction, sterilizing, immobilizing and/or killing a biological organism. In some embodiments, such organisms are pests. In some embodiments, such pests are bed bugs. In some embodiments, biocides may target juvenile bed bugs, known as nymphs.

In some embodiments, biocides of the present invention may be lethal. As used herein the term “lethal” is used to refer to any agent capable of causing death in one or more organisms that are exposed to such an agent. In some embodiments, such organisms are pests. In some embodiments, such pests are bed bugs. As used herein, the term “lethality” refers to the capability of a given agent to cause death in one or more organisms exposed to such an agent.

### Compounds, Compositions and Combinations

Biocidal, repellent and/or attractant compounds and/or compositions of the present invention, including those capable of killing and/or modifying bed bug behavior, may include any of those disclosed in International Patent Application number PCT/US13/55330, the contents of which are herein incorporated by reference in their entirety. Specifically, activators of carbon dioxide sensory neurons may include any of those listed in Table 1 of PCT/US13/55330, inhibitors of carbon dioxide sensory neurons may include any of those listed in Table 2 of PCT/US13/55330, biocidal compounds may include any of those listed in Table 4 of PCT/US13/55330 and larvicidal compounds may include any of those listed in Table 5 of PCT/US13/55330. Additionally activator combinations may include any of those listed in Tables 7, 8, 9 and 15 of PCT/US13/55330 Inhibitor combinations may include any of those listed in Tables 11, 12, 13, 14 and 16 of PCT/US13/55330. Biocidal combinations may include any of those listed in Table 19 of PCT/US13/55330.

According to the present invention, compounds useful for modifying bed bug behavior have been identified. Such compounds may include, but are not limited to any of those listed in Table 1.

TABLE 1
Compounds of the invention

| Compound | |
|---|---|
| No. | Compound |
| BBC001 | trans-cinnamaldehyde |
| BBC002 | eugenol |
| BBC003 | 4-ethylphenol |
| BBC004 | indole |
| BBC005 | phenyl propyl aldehyde |
| BBC006 | 2-methoxy-3(5or6) isopropylpyrazine |
| BBC007 | 2,3-diethyl-5-methylpyrazine |
| BBC008 | ethyl 3-hydroxyhexanoate |
| BBC009 | furfuryl pentanoate |
| BBC010 | cinnamyl formate |
| BBC011 | guaiacol |
| BBC012 | phenylacetaldehyde dimethyl acetate |
| BBC013 | cinnamic aldehyde dimethyl acetal |
| BBC014 | methyl heptadienone |
| BBC015 | 2-acetyl-5-methyl furan |
| BBC016 | ultrazur |
| BBC017 | cis-5-octen-1-ol |
| BBC018 | 2,3-dimethylpyrazine |
| BBC019 | trans-2-decenal |
| BBC020 | peppermint oil |
| BBC021 | gamma-heptalactone |
| BBC022 | methyl trans-cinnamate |
| BBC023 | methyl cinnamate |
| BBC024 | 2-furyl methyl ketone |
| BBC025 | menthol |
| BBC026 | hexyl butyrate |
| BBC027 | 2,3,5-trimethylpyrazine |
| BBC028 | ethyl cinnamate |
| BBC029 | cinnamyl nitrile |
| BBC030 | allyl cinnamate |
| BBC031 | phenylacetaldehyde |
| BBC032 | 2-ethylpyrazine |
| BBC033 | 1-ethylhexyl tiglate |
| BBC034 | 5-methyl furfural |
| BBC035 | hexyl formate |
| BBC036 | ethyl 2-furoate |
| BBC037 | cinnamyl propionate |
| BBC038 | 2,4-lutidine |
| BBC039 | methyl crotonate |
| BBC040 | ethyl lactate |
| BBC041 | 2-methyltetrahydrofuran-3-one |
| BBC042 | trans-cinnamyl propionate |
| BBC043 | valeraldehyde |
| BBC044 | 2-ethyl-3-methoxypyrazine |
| BBC045 | 2,3-diethylpyrazine |
| BBC046 | methoxy cinnamic aldehyde |
| BBC047 | 2-methoxypyrazine |
| BBC048 | benzyl cinnamate |
| BBC049 | methyl levulinate |
| BBC050 | methyl heptanoate |
| BBC051 | isoamyl propionate |
| BBC052 | methyl (E)-hex-3-enoate |
| BBC053 | ethyl vinyl carbinol |
| BBC054 | menthalactone |
| BBC055 | 2-ethyl-3-methylpyrazine |
| BBC056 | allyl butyrate |
| BBC057 | heptanone-4 |
| BBC058 | cis-3-hexenyl formate |
| BBC059 | butyl formate |
| BBC060 | methanethiol acetate |
| BBC061 | octanone-3 |
| BBC062 | trans-2-methyl-2-butenal |
| BBC063 | cis-3-hexenyl acetate |
| BBC064 | phenethyl cinnamate |
| BBC065 | 2-pentanone |
| BBC066 | ethyl acetoacetate |
| BBC067 | 2-methoxy-3-methylpyrazine |
| BBC068 | cinnamyl isobutyrate |
| BBC069 | cyclopentanone |
| BBC070 | propyl formate |
| BBC071 | 1-octanol |
| BBC072 | pyrazine |
| BBC073 | p-Tolyl acetate |
| BBC074 | methyl propionate |
| BBC075 | phenethyl formate |
| BBC076 | phenethyl acetate |
| BBC077 | 1-octen-3-yl acetate |
| BBC078 | octyl butyrate |
| BBC079 | phenethyl propionate |
| BBC080 | salicylaldehyde |
| BBC081 | (Z)-hept-3-enylacetate |
| BBC082 | geranyl acetone |
| BBC083 | isoamyl formate |
| BBC084 | alpha,alpha-dimethyl phenethyl butyrate |
| BBC085 | veratraldehyde |
| BBC086 | cis-3-hexenyl butyrate |

Many of these compounds can be categorized according to different structural and chemical properties. These categories include, but are not limited to aromatic compounds, pyrazine ring-containing compounds, furan ring-containing compounds, ketones, aldehydes, acetates, essential oils, environmentally safe compounds, flavoring agents and odorants.

Pyrazine compounds—compounds and compositions are disclosed herein containing components with one or more pyrazine ring structures. Pyrazine rings can be formed through the pyrolysis of natural amino acid precursors including serine and threonine in the presence of sugars such as glucose and fructose (Teranishi, R., Flavor Chemistry: Thirty Years of Progress, Springer, 1999, p330; the contents of which are herein incorporated by reference in their entirety.) They are found in a variety of food items, especially those processed at elevated temperatures in the absence of water. Pyrazine compounds of the present invention include, but are not limited to BBC006; BBC007; BBC018; BBCO27; BBC044; BBC045; BBC047; BBC055; and BBC067.

Furan compounds—compounds and compositions are disclosed herein containing components with one or more furan ring structures. Many of these compounds can be found in nature or are synthetic chemicals closely resembling those in nature. Furans themselves are cyclic and contain the formula C₄H₄O. They are often used as the starting point for chemical synthesis of other compounds. Furan compounds of the present invention include, but are not limited to BBC041; BBC009; BBC015; BBCO24; BBC034; and BBC036.

Essential oils—compounds and compositions are disclosed herein that contain essential oils and/or compounds derived from essential oils. The term “essential oil” as used herein refers to any volatile aromatic liquid extracted from plants. Typically these compounds carry a distinctive scent of the plant from which they were extracted. Extraction is typically carried out by distillation allowing for extraction of concentrated compounds. Essential oils of the present invention include, but are not limited to rosemary oil, eucalyptol, peppermint oil and eugenol. Essential oils also include cinnamon oil, clove oil, mint oil, jasmine oil, geraniol, camphor oil, hinoki oil, sage oil, tohi oil, pomegranate oil, rose oil, turpentine oil, bergamot oil, mandarin oil, pine oil, calamus oil, lavender oil, bay oil, hiba oil, lemon oil, thyme oil, menthol, cineole, citral, citronella, linalool, borneol, camphor, thymol, spilanthole, pinene, terpene, limonene and the like. It is known in the art that some essential oils or combinations thereof, have repellent and/or attractant properties with regard to insects.

Eugenol (BBC002) is a phenolic compound found at high levels in clove oil and is known to have strong antimicrobial and insecticidal activity. Interestingly, it can also act as an attractant for some insects, such as Japanese beetles. Its presence on the list of FIFRA exempt compounds makes it an attractive candidate for use in insecticides, repellents or lures. Eugenol has been shown herein to repel bed bugs. In some cases, eugenol may be used as a bed bug repellent and/or be included in a bed bug repellent blend according to the present invention.

Peppermint oil is extracted from the peppermint plant, a hybrid of watermint and spearmint. It is currently used in natural pesticides due to the presence of menthone, a known repellent agent. Peppermint oil has been shown herein to repel bed bugs. In some cases, peppermint oil may be used as a bed bug repellent and/or be included in a bed bug repellent blend according to the present invention.

Rosemary oil is extracted from the rosemary plant. It has a strong aroma and is a natural component of some pesticides. Blends comprising rosemary oil have been shown herein to repel bed bugs. In some cases, rosemary oil may be used as a bed bug repellent and/or be included in a bed bug repellent blend according to the present invention.

Guaiacol is a natural compound and a component of wood-tar creosote. It is aromatic and has been used medicinally as an antipyretic, antiseptic and expectorant. In some embodiments, compounds and/or compositions of the present invention comprise guaiacol. Guaiacol has been shown herein to repel bed bugs. In some cases, guaiacol may be used as a bed bug repellent and/or be included in a bed bug repellent blend according to the present invention.

### Blends

In some embodiments, compositions of the present invention may comprise blends of one or more compounds disclosed herein. As used herein, the term “blend” refers to a composition that is produced by the mixing or combining of two or more components. In some cases, blends may comprise compounds that act synergistically with regard to their biocidal activity and/or ability to modify bed bug behavior. Blends of the present invention may include combinations of one or more of any of the compounds listed in Table 1. Further, blends of the present invention may include any of those listed in Table 2.

TABLE 2
Blends of the invention

| Blend | | | |
|---|---|---|---|
| No. | Compound A | Compound B | Compound C |
| BBB001 | 2,3-diethylpyrazine | 2-methoxy-3- | x |
| | | methylpyrazine | |
| BBB002 | phenethyl propionate | furfuryl pentanoate | x |
| BBB003 | cinnamyl nitrile | phenyl propyl aldehyde | x |
| BBB004 | cinnamyl nitrile | 2,3-dimethylpyrazine | x |
| BBB005 | cinnamyl nitrile | 2,3,5-trimethyl pyrazine | x |
| BBB006 | 2-furyl methyl ketone | 2,3-dimethylpyrazine | x |
| BBB007 | 2-furyl methyl ketone | 2,3,5 trimethylpyrazine | x |
| BBB008 | 2-acetyl-5-methyl furan | phenyl propyl aldehyde | x |
| BBB009 | 2-acetyl-5-methyl furan | gamma heptalactone | x |
| BBB010 | rosemary oil | eugenol | x |
| BBB011 | eugenol | veratraldehyde | x |
| BBB012 | eugenol | 1-octanol | x |
| BBB013 | eugenol | cis-3-hexenyl butyrate | x |
| BBB014 | eugenol | cis-5-octen-1-ol | x |
| BBB015 | eugenol | (Z)-hept-3-enylacetate | x |
| BBB016 | 2,3-dimethylpyrazine | 2,3,5-trimethylpyrazine | x |
| BBB017 | 2,3-dimethylpyrazine | ethyl 3- | x |
| | | hydroxyhexanoate | |
| BBB018 | 2,3-dimethylpyrazine | phenyl acetaladehyde | x |
| BBB019 | gamma-heptalactone | ethyl 3- | x |
| | | hydroxyhexanoate | |
| BBB020 | gamma-heptalactone | phenylacetaldehyde | x |
| BBB021 | 2-ethylpyrazine | 2,4-lutidine | x |
| BBB022 | butyl formate | 2,4-lutidine | x |
| BBB023 | methyl (E)-hex-3-enoate | 2,3-diethylpyrazine | 1 octanol |
| BBB024 | methyl (E)-hex-3-enoate | 2,3-diethylpyrazine | furfuryl |
| | | | pentanoate |
| BBB025 | 2,3-diethylpyrazine | eugenol | 1 octanol |
| BBB026 | 2,3-diethylpyrazine | eugenol | (Z)-hept-3- |
| | | | enylacetate |
| BBB027 | ethyl acetoacetate | cinnamyl nitrile | x |
| BBB028 | ethyl acetoacetate | 2-acetyl-5-methyl furan | x |
| BBB029 | isoamyl propionate | 2,3,5-trimethylpyrazine | x |
| BBB030 | trans-2-methyl-2-butenal | 2,4-lutidine | x |
| BBB031 | methyl levulinate | phenyl propyl aldehyde | x |
| BBB032 | 5-methylfurfural | 2,4-lutidine | x |
| BBB033 | methyl levulinate | gamma-heptalactone | x |
| BBB034 | geranyl acetone | eugenol | x |
| BBB035 | eugenol | alpha,alpha-dimethyl | x |
| | | phenethyl butyrate | |
| BBB036 | eugenol | furfuryl pentanoate | x |
| BBB037 | hexyl formate | gamma-heptalactone | x |
| BBB038 | 2,3-dimethylpyrazine | gamma heptalactone | x |
| BBB039 | 5-methylfurfural | 2-methoxypyrazine | x |
| BBB040 | cinnamyl nitrile | gamma-heptalactone | x |
| BBB041 | gamma-heptalactone | 2-pentanone | x |
| BBB042 | methyl (E)-hex-3-enoate | 2-acetyl-5-methylfuran | x |
| BBB043 | methyl levulinate | cinnamyl nitrile | x |
| BBB044 | ethyl 3- | phenylacetaldehyde | x |
| | hydroxyhexanoate | | |
| BBB045 | 2-furyl methyl ketone | 2-acetyl-5-methyl furan | x |
| BBB046 | 5-methylfurfural | ethyl lactate | x |
| BBB047 | 5-methylfurfural | ethyl vinyl carbinol | x |
| BBB048 | rosemary oil | cis-5-octen-1-ol | x |
| BBB049 | methyl (E)-hex-3-enoate | 2,3-diethylpyrazine | eugenol |
| BBB050 | 2,3,5-trimethyl pyrazine | gamma heptalactone | x |
| BBB051 | ethyl acetoacetate | gamma-heptalactone | x |
| BBB052 | 5-methylfurfural | 2-ethylpyrazine | x |
| BBB053 | phenyl propyl aldehyde | gamma heptalactone | x |
| BBB054 | cyclopentanone | 2,4-lutidine | x |
| BBB055 | geranyl acetone | rosemary oil | x |
| BBB056 | 2,3-diethyl-5- | 2-methoxy-3- | x |
| | methylpyrazine | methylpyrazine | |
| BBB057 | phenethyl propionate | trans-2-decenal | x |
| BBB058 | 2-ethyl-3- | trans-2-decenal | x |
| | methoxypyrazine | | |
| BBB059 | 2,3,5-trimethyl pyrazine | 2-pentanone | x |
| BBB060 | cinnamyl nitrile | 2-furyl methyl ketone | x |
| BBB061 | cis-3-hexenyl formate | gamma-heptalactone | x |
| BBB062 | phenethyl propionate | 2-methoxy-3(5or6) | x |
| | | isopropylpyrazine | |
| BBB063 | ethyl lactate | 2,4-lutidine | x |
| BBB064 | methyl levulinate | 2,3-dimethylpyrazine | x |
| BBB065 | ethyl lactate | 2-methoxypyrazine | x |
| BBB066 | methyl levulinate | 2,3,5-trimethylpyrazine | x |
| BBB067 | methyl levulinate | ethyl 3- | |
| | | hydroxyhexanoate | |
| BBB068 | hexyl formate | 2,3,5-trimethylpyrazine | x |
| BBB069 | 2-ethylpyrazine | 2-methyltetrahydrofuran- | x |
| | | 3-one | |
| BBB070 | methyl (E)-hex-3-enoate | gamma-heptalactone | x |
| BBB071 | butyl formate | 2-ethylpyrazine | x |
| BBB072 | trans-2-methyl-2-butenal | 2-methyltetrahydro | x |
| | | furan-3-one | |
| BBB073 | methyl (E)-hex-3-enoate | 2,3-diethylpyrazine | (Z)-hept-3- |
| | | | enylacetate |
| BBB074 | hexyl formate | 2-furyl methyl ketone | x |
| BBB075 | isoamyl formate | gamma-heptalactone | x |
| BBB076 | 2-acetyl-5-methyl furan | ethyl 3-hydroxy | x |
| | | hexanoate | |
| BBB077 | methyl (E)-hex-3-enoate | 2,3-dimethylpyrazine | x |
| BBB078 | methyl (E)-hex-3-enoate | 2,3,5-trimethylpyrazine | x |
| BBB079 | 2-methoxypyrazine | ethyl vinyl carbinol | x |
| BBB080 | ethyl 3-hydroxy | 2-pentanone | x |
| | hexanoate | | |
| BBB081 | ethyl acetoacetate | 2,3-dimethylpyrazine | x |
| BBB082 | ethyl acetoacetate | 2-furyl methyl ketone | x |
| BBB083 | 5-methylfurfural | butyl formate | x |
| BBB084 | 5-methylfurfural | cyclopentanone | x |
| BBB085 | ethyl vinyl carbinol | 2-methyltetrahydro | x |
| | | furan-3-one | |
| BBB086 | ethyl lactate | cyclopentanone | x |
| BBB087 | butyl formate | 2-methyltetrahydro | x |
| | | furan-3-one | |
| BBB088 | methyl heptanoate | methanethiol acetate | |
| BBB089 | butyl formate | cyclopentanone | x |
| BBB090 | methyl levulinate | methyl crotonate | x |
| BBB091 | 2,3-diethylpyrazine | 2,3-diethyl-5- | x |
| | | methylpyrazine | |
| BBB092 | 2-ethylpyrazine | 2-methoxypyrazine | x |
| BBB093 | cyclopentanone | 2-methoxypyrazine | x |
| BBB094 | ethyl acetoacetate | ethyl 3-hydroxy | x |
| | | hexanoate | |
| BBB095 | methyl levulinate | 2-pentanone | |
| BBB096 | ethyl acetoacetate | 2,3,5-trimethyl pyrazine | x |
| BBB097 | isoamyl formate | 2,3,5-trimethylpyrazine | x |
| BBB098 | cyclopentanone | ethyl vinyl carbinol | x |
| BBB099 | trans-2-methyl-2-butenal | cyclopentanone | x |
| BBB100 | methyl levulinate | methanethiol acetate | x |
| BBB101 | 2-ethyl-3- | octanone-3 | x |
| | methoxypyrazine | | |
| BBB102 | ethyllactate | ethyl vinyl carbinol | x |
| BBB103 | ethyllactate | 2-methyltetrahydro | x |
| | | furan-3-one | |
| BBB104 | cyclopentanone | 2-ethylpyrazine | x |
| BBB105 | butyl formate | 2-methoxypyrazine | x |
| BBB106 | ethyllactate | butyl formate | x |
| BBB107 | ethyllactate | 2-ethylpyrazine | x |
| BBB108 | cyclopentanone | ethylacetoacetate | x |
| BBB109 | 2,3,5-trimethylpyrazine | phenylacetaldehyde | x |
| BBB110 | methyl (E)-hex-3-enoate | 2,3-diethylpyrazine | 2-ethyl-3- |
| | | | methoxypyrazine |
| BBB111 | furfuryl pentanoate | 2-ethyl-3- | 2-methoxy- |
| | | methoxypyrazine | 3(5or6) |
| | | | isopropylpyrazine |
| BBB112 | 2-methoxy-3(5or6) | 2-ethyl-3- | 1-octanol |
| | isopropylpyrazine | methoxypyrazine | |
| BBB113 | phenethyl propionate | 2-ethyl-3- | x |
| | | methoxypyrazine | |
| BBB114 | 2-ethyl-3- | 2-methoxy-3(5or6) | x |
| | methoxypyrazine | isopropylpyrazine | |
| BBB115 | 2-ethyl-3- | cis-3-hexenyl acetate | x |
| | methoxypyrazine | | |
| BBB116 | methyl (E)-hex-3-enoate | 2-ethyl-3- | x |
| | | methoxypyrazine | |
| BBB117 | 2-ethylpyrazine | ethyl vinyl carbinol | x |
| BBB118 | 2-methoxypyrazine | ethyl vinyl carbinol | x |
| BBB119 | 1-octanol | eugenol | 2-ethyl-3- |
| | | | methoxypyrazine |
| BBB120 | propyl formate | 2-pentanone | x |

With regard to bed bug activity, repellent compounds and blends of the present invention may be divided into mild, moderate, strong and very strong repellent categories. A mild repellent compound or blend typically yields a repellency value of 20-40% when tested according to the bed bug repellency assay described hereinbelow. By the same assay, a moderate repellent compound or blend typically yields a repellency value of 40-60%, a strong repellent compound or blend typically yields a repellency value of 60-80% and a very strong repellent compound or blend typically yields a repellency value of 80-100%.

With regard to bed bug activity, attractant compounds and blends of the present invention may be divided into mild, moderate, strong and very strong attractant categories. A mild attractant compound or blend typically yields an attractant activity value of 10-20% when tested according to the bed bug luring assay described hereinbelow. By the same assay, a moderate attractant compound or blend typically yields an attractant activity value of 20-40%, a strong attractant compound or blend typically yields an attractant activity value of 40-60% and a very strong attractant compound or blend typically yields an attractant activity value of >60%.

### Synergistic Blends

It has been unexpectedly found that certain compounds of the invention, when combined, demonstrate enhanced repellent and/or attractant activity. Such combinations are referred to herein as “synergistic blends.” For example, some blends were found to be very strong repellents although comprising compounds from lower repellent categories.

### Antagonistic Blends

In some cases, combining attractant or repellent compounds with one or more other compounds was found to mute the ability of such attractant or repellent compounds to modify pest behavior. Such blends are referred to herein as “antagonistic blends.” For example, some blends were found to be mild attractants although comprising a strong attractant.

### Formulations

Compounds disclosed herein may be formulated. As used herein, a “formulation” is a combination of one or more compounds or blends prepared as per a formula and may include one or more excipients. As used herein, an “excipient” refers to any component of a formulation other than the active component(s). Formulations may be dry or wet or may be solid or liquid. Formulations may be designed for one or more particular applications or uses.

Generating formulations may include the step of bringing compounds and/or blends of the present invention into association with an excipient and/or one or more other accessory ingredients, and then, if necessary and/or desirable, dividing, shaping and/or packaging the resulting formulation into a desired single- or multi-unit format.

Relative amounts of the components of formulations in accordance with the invention will vary, depending upon the application, substrate, amount of area to be covered, etc. By way of example, formulations may comprise between 0.1% and 100%, e.g., between 0.5 and 50%, between 1-30%, between 5-80%, at least 80% (w/w) compounds and/or blends of the invention.

Compounds and/or blends of the present invention may be formulated using one or more excipients to: (1) increase stability; (2) modulate exposure to pests; (3) permit the sustained or delayed release (e.g., from a depot formulation); (4) alter the distribution (e.g. through aerosolization); and/or (5) enhance other properties or modes of application. Excipients may include, but are not limited to any and all solvents, dispersion media, diluents, or other liquid vehicles, dispersion or suspension aids, surface active agents, isotonic agents, thickening or emulsifying agents and preservatives.

Accordingly, the formulations of the invention can include one or more excipients, each in an amount that may increase the stability of and/or permit the sustained or delayed release of compounds and/or blends of the invention. Further formulations may include one or more excipients each in an amount that may modulate exposure of compounds and/or blends to pests or alter the distribution of compounds and/or blends during application.

Formulations of the compounds and/or blends of the present invention may be deployed by aerosolization via sublimation, spray, vaporization, candle burning and the like. They may be deployed as solids such as blocks, rods, crystals, granules, pellets, beads, powders and the like for release of vapors over time. Said formulations may be designed for slow release.

In another embodiment, the compounds and/or blends of the invention may be used in liquid form, either as purified liquids or in aqueous-based or non-aqueous (organic) formulations. As used herein the term “aqueous” means similar to or containing or dissolved in water, e.g., an aqueous solution. A “slurry” according to the present invention is a suspension of predominantly insoluble particles, usually in water. Suitable liquid diluents or carriers include water, petroleum distillates, or other liquid carriers. In one embodiment, said diluents further comprise surface active agents. Non-ionic, anionic, amphoteric, or cationic dispersing and emulsifying agents may be employed. The choice of liquid formulation components is dictated by the intended use of the formulation, the desired distribution of the active compounds within the formulation or the ability of the formulation to be effectively spread across the desired treatment area. Said liquid formulations may be in the form of lotions, sprays, aerosols, foams, gels, balms, creams, mousse, patches (comprising such liquid formulations), suspensions, emulsions, microemulsions, emulsifiable concentrates, pump sprays, fragrances, perfumes, colognes, roll ons, solid sticks, gel sticks, towelettes, wipes, wet wipes, ointments, salves, pastes and the like.

In one embodiment, formulations may be used as a repellent to repel bed bugs from a given area or from the vicinity of an individual or group of individuals. In another embodiment, formulations may be attractant formulations utilized to draw bed bugs to a given site or away from a less desired site. The site of attraction may be a trap or device deployed to capture or otherwise attract the bed bugs.

Compounds and/or blends of the invention may be formulated with other attractants known in the art. These attractant formulations may comprise one or more of the following: sugar, honey, molasses, plant oils, animal oils such as fish oil and the like, plant extracts, floral odors, pheromones, proteins, salt, seeds, animal feed, livestock feed, sticky agents, adhesives including substances such as tanglewood and the like. In another embodiment, activator formulations may be utilized as a protectant to prevent bed bug attraction to a subject or group of subjects desired to be protected. Protectant formulations may act to overwhelm CO₂-responsive/skin responsive neurons in bed bugs, rendering them unable to track CO₂ plumes exhaled from subjects or groups of subjects desired to be protected.

The compounds and/or blends of the invention may be formulated for topical use on a given subject. In one embodiment, these topical formulations may be applied to a subject's skin. In a further embodiment the subjects may be non-human animals such as dogs, cats, horses, equines, bovines, pigs and others that exhale carbon dioxide and/or are vulnerable to bed bugs. The compounds and/or blends may also be formulated for application to materials such as subject clothing or apparel. Such materials may also include bedding, netting, bed netting, screens, curtains, walls, gear, equipment, patches, vehicles and the like.

Formulations containing compounds or blends of the present invention may comprise carriers, thickeners, surface-active agents, preservatives, aromatics, deodorizers, sunscreen active and one or more of several types of adjuvant including, but not limited to, wetting agents, spreading agents, sticking agents, foam retardants, buffers and acidifiers. As used herein, “sunscreen active” is an additive capable of absorbing or reflecting a portion of the solar ultraviolet radiation from a surface.

In another embodiment, the compounds and/or blends of the present invention may be supplied as a concentrate which may be diluted to achieve a desired strength depending on the application. The term “concentrate” as used herein, refers to a compound or blend in condensed form. A concentrate therefore may contain some diluents and not necessarily be purified.

### Carriers

The compounds and/or blends of the present invention may contain one or more carriers or carrier vehicles. These carriers may be gaseous, liquid or solid and are most often inert but may be active ingredients. Carrier vehicles may include, but are not limited to, aerosol propellants, such as freon, (present in a gaseous state at normal temperatures and pressures); inert dispersible liquid diluent carriers, including inert organic solvents, aromatic hydrocarbons (such as benzene, toluene, xylene, alkyl naphthalenes, etc.), halogenated especially chlorinated, aromatic hydrocarbons (such as chloro-benzenes, etc.), chlorinated aliphatic hydrocarbons (such as chloroethylenes, methylene chloride, etc.), cycloalkanes, (such as cyclohexane, etc.), paraffins (such as petroleum or mineral oil fractions), acetonitrile, ketones (such as cyclohexanone, methyl ethyl ketone, acetone, methyl isobutyl ketone, etc.), alcohols (such as ethanol, methanol, propanol, glycol, butanol, etc.) as well as ethers and esters thereof (such as glycol monomethyl ether, etc.), amides (such as dimethylformamide etc.), amines (such as ethanolamine, etc.), sulfoxides (such as dimethylsulfoxide, etc.), and/or water. Carriers may also include inert, finely divided solid carriers that may be dispersible such as ground natural minerals (including, but not limited to chalk, i.e. calcium carbonate, silica, alumina, vermiculite, talc, kieselguhr, attapulgite, montmorillonite, etc.) as well as ground synthetic minerals (such as highly dispersed silicic acid, silicates, such as alkali silicates, etc.).

### Finely Divided Solid Carrier Formulations

The compounds and/or blends of the present invention may be formulated for dispersion with finely divided solid carriers such as dust, talc, chalk, diatomaceous earth, vermiculite, sand, sulfur, flours, attapulgite clay, kieselguhr, pyrophyllite, calcium phosphates, calcium and magnesium carbonates, and other solids capable of acting as carriers. A typical finely divided solid formulation useful for modifying bed bug behavior contains 1 part compound or blend per 99 parts of said finely divided solid carrier. In one embodiment, these finely divided solids have an average particle size of about >50 microns. In another embodiment, said finely divided solids are granules. The term “granule,” as used herein refers to particles of a diameter of about 400-2500 microns. Said granules may comprise porous or nonporous particles. Finely divided solid carriers may be either impregnated or coated with the desired compound or blend. Granules generally contain 0.05-15%, preferably 0.5-5%, of the active compound or blend. Thus, the repellent compounds or blends of the present invention can be formulated with any of the following solid carriers such as bentonite, fullers earth, ground natural minerals (such as kaolins, quartz, attapulgite, montmorillonite, etc.), ground synthetic minerals (such as highly-dispersed silicic acid, alumina and silicates), crushed and fractionated natural rocks (such as calcite, marble, pumice, sepiolite and dolomite), synthetic granules of inorganic and organic meals, and granules of organic materials (such as sawdust, coconut shells, corn cobs, tobacco stalks, walnut or other nut shells, egg shells and other natural cast off products that may or may not be a by-product of manufacturing or harvest).

### Surface-Active Agents

Formulations containing compounds and/or blends of the present invention may include surface-active agents. “Surface-active agents” as referred to herein, are additives capable of lowering the surface tension of a liquid or between a liquid and a solid. Surface-active agents may include, but are not limited to emulsifying agents (such as non-ionic and/or anionic emulsifying agents, polyethylene oxide esters of fatty acids, polyethylene oxide ether of fatty alcohols, alkyl sulfates, alkyl sulfonates, aryl sulfonates, albumin hydrolyzates, alkyl arylpolyglycol ethers, magnesium stearate, sodium oleate, etc.) and/or dispersing agents (such as lignin, sulfite waste liquors, methyl cellulose, etc.)

### Thickeners

Formulations containing compounds or blends of the present invention may contain one or more thickeners. The term “thickener”, as used herein refers to an additive that increases the viscosity of the formulation to which it is added without significantly modifying other properties of the formulation. They may also be used to impart a uniform consistency to the formulation. They are also useful for keeping components of a given formulation in suspension. Said thickeners include, but are not limited to agar, corn starch, guar gum and potato starch. Thickeners may be present at a concentration from about 0.1% to about 5% of the total formulation.

### Preservatives

Formulations containing compounds or blends of the present invention may contain one or more preservatives. The term “preservative”, as used herein refers to an additive capable of preventing decay, decomposition or spoilage in a formulation. Said preservatives may be natural or synthetic; they may protect against a broad spectrum of spoilage or be targeted to one form (such as microbial, fungal or molding spoilage). Preservatives may include, but are not limited to calcium propionate, sodium nitrate, sodium nitrite, sulfur dioxide, sodium bisulfate, potassium hydrogen sulfite, disodium ethylenediaminetetraacetic acid (EDTA), formaldehyde, glutaraldehyde, ethanol, methylchloroisothiazolinone, potassium sorbate and the like. Other preservatives protect against chemical breakdown of compounds or blends. Such preservatives include butylated hydroxyanisole (BHA) and butylated hydroxytoluene (BHT). Preservatives are typically present in formulations at a concentration from about 0.03% to about 3% by weight.

### Other Ingredients

The compounds and/or blends of the invention may include “other ingredients” known to those skilled in the art and which may be added to formulations depending on the desired application. These include, but are not limited to milk, garlic, garlic powder, garlic oil, hot pepper, white pepper, oil of black pepper, piperine, chemically formulated pepper, clove, fish oil, optionally modified oil, onion, perfumes, bitrex, thiram, thymol, capsaicin, predator urines, urea, naphthalene (moth balls), pyrethrine, blood, blood meal, bone meal, sulfurous emitting items (eggs, sulfur, meats, etc), denatonium benzoate, formaldehyde, ammonia, methyl ammonium saccharide, ammonium of fatty acids, waxes, nutrients, butyl mercaptan, mineral oil, orange oil, kelp (seaweed), whole eggs, powdered eggs, putrescent eggs, egg whites, egg yolks, rotten eggs, rosemary, thyme, wintergreen, clay, 2-propenoic acid, potassium salt, 2-propeniamide, acetic acid, iron, manganese, boron, copper, cobalt, molybdenum, zinc, latex, animal glue and stickers like nufilm p and others in the series.

### Environmentally Safe Compounds

Formulations of compounds and/or blends of the invention may contain environmentally safe compounds. As used herein, an “environmentally safe compound” is a compound that imposes reduced, limited, minimal and/or no harm to a given ecosystem or environment. Harmful chemicals are often used to control pests and biting insects. With increasing public awareness of the dangers posed by some chemicals to public health and to the environment, natural compounds have been increasingly explored as alternatives to synthetic and/or hazardous chemicals. To this end, the Environmental Protection Agency has taken legislative action to categorize certain natural compounds as safe, protecting the use of these environmentally safe compounds from certain government regulations. The Federal Insecticide, Fungicide and Rodenticide Act (FIFRA) outlines the exemptions as well as compounds covered by the act. In some embodiments, environmentally safe compounds include those identified as environmentally safe to use in pesticides by the Federal Insecticide, Fungicide and Rodenticide Act (FIFRA). Such compounds include, but are not limited to: (+)-butyl lactate; (+)-ethyl lactate; 1,2-propylene carbonate; 1-monolaurin; 1-monomyristin; 2-phenethyl propionate (2-phenylethyl propionate); acetyl tributyl citrate; agar; almond hulls; almond shells; alpha-cyclodextrin; aluminatesilicate; aluminum magnesium silicate; aluminum potassium sodium silicate; aluminum silicate; aluminum sodium silicate; aluminum sodium silicate (1:1:1); ammonium benzoate; ammonium stearate; amylopectin, acid-hydrolyzed, 1-octenylbutanedioate; amylopectin, hydrogen 1-octadecenylbutanedioate; animal glue; ascorbyl palmitate; attapulgite-type clay; beeswax; bentonite; bentonite, sodian; beta-cyclodextrin; bone meal; bran; bread crumbs; butyl lactate; butyl stearate; calcareous shale; calcite (Ca(Co₃)); calcium acetate; calcium acetate monohydrate; calcium benzoate; calcium carbonate; calcium citrate; calcium octanoate; calcium oxide silicate (Ca₃O(SiO₄)); calcium silicate; calcium stearate; calcium sulfate; calcium sulfate dihydrate; calcium sulfate hemihydrate; canary seed; carbon; carbon dioxide; carboxymethyl cellulose; cardboard; carnauba wax; carob gum; carrageenan; caseins; castor oil; castor oil, hydrogenated; cat food; cedar oil; cellulose; cellulose acetate; cellulose mixture (with cellulose carboxymethyl ether, sodium salt); cellulose, pulp; cellulose, regenerated; cheese; chlorophyll a; chlorophyll b; cinnamon and cinnamon oil; citric acid; citric acid, monohydrate; citronella and citronella oil; citrus meal; citrus pectin; citrus pulp; clam shells; cloves and clove oil; cocoa; cocoa shell flour; cocoa shells; cod-liver oil; coffee grounds; cookies; cork; corn cobs; corn gluten meal; corn oil; cotton; cottonseed meal; cottonseed oil; cracked wheat; decanoic acid, monoester with 1,2,3-propanetriol; dextrins; diatomaceous earth (less than 1% crystalline silica); diglyceryl monooleate; diglyceryl monostearate; dilaurin; dipalmitin; dipotassium citrate; disodium citrate; disodium sulfate decahydrate; dodecanoic acid, monoester with 1,2,3-propanetriol; dolomite; douglas fir bark; dried blood; egg shells; eggs; ethyl lactate; eugenol; feldspar; fish meal; fish oil (not conforming to 40 CFR 180.950); fuller's earth; fumaric acid; gamma-cyclodextrin; garlic and garlic oil; gelatins; gellan gum; geraniol; geranium oil; glue (as depolymd. animal collagen); glycerin; glycerol monooleate; glyceryl dicaprylate; glyceryl dimyristate; glyceryl dioleate; glyceryl distearate; glyceryl monomyristate; glyceryl monooctanoate; glyceryl monooleate; glyceryl monostearate; glyceryl stearate; granite; graphite; guar gum; gum arabic; gum tragacanth; gypsum; hematite (Fe₂O₃); humic acid; hydrogenated cottonseed oil; hydrogenated rapeseed oil; hydrogenated soybean oil; hydroxyethyl cellulose; hydroxypropyl cellulose; hydroxypropyl methyl cellulose; Iron magnesium oxide (Fe₂MgO₄); iron oxide (Fe₂O₃); iron oxide (Fe₂O₃), hydrate; iron oxide (Fe₃O₄); iron oxide (FeO); isopropyl alcohol; isopropyl myristate; kaolin; lactose; lactose monohydrate; lanolin; latex rubber; lauric acid; lauryl sulfate; lecithins; lemon grass oil; licorice extract; lime (chemical) dolomitic; limestone; linseed oil; magnesium benzoate; magnesium carbonate; magnesium oxide; magnesium oxide silicate (Mg₃O(Si₂O₅)₂), monohydrate; magnesium silicate; magnesium silicate hydrate; magnesium silicon oxide (Mg₂Si₃O₈); magnesium stearate; magnesium sulfate; magnesium sulfate heptahydrate; malic acid; malt extract; malt flavor; maltodextrin; methylcellulose; mica; mica-group minerals; milk; millet seed; mineral oil (U.S.P); mint and mint oil; monomyristin; monopalmitin; monopotassium citrate; monosodium citrate; montmorillonite; myristic acid; nepheline syenite; nitrogen; nutria meat; nylon; octanoic acid, potassium salt; octanoic acid, sodium salt; oils, almond; oils, wheat; oleic acid; oyster shells; palm oil; palm oil, hydrogenated; palmitic acid; paper; paraffin wax; peanut butter; peanut shells; peanuts; peat moss; pectin; peppermint and peppermint oil; perlite; perlite, expanded; plaster of paris; polyethylene; polyglyceryl oleate; polyglyceryl stearate; potassium acetate; potassium aluminum silicate, anhydrous; potassium benzoate; potassium bicarbonate; potassium chloride; potassium citrate; potassium humate; potassium myristate; potassium oleate; potassium ricinoleate; potassium sorbate; potassium stearate; potassium sulfate; pumice; putrescent whole egg solids; red cabbage color (expressed from edible red cabbage heads via a pressing process using only acidified water); red cedar chips; red dog flour; rosemary and rosemary oil; rubber; sawdust; sesame (includes ground sesame plant stalks) and sesame oil; shale; silica (crystalline free); silica gel; silica gel, precipitated, crystalline-free; silica, amorphous, fumed (crystalline free); silica, amorphous, precipated and gel; silica, hydrate; silica, vitreous; silicic acid (H₂SiO₃), magnesium salt (1:1); soap (the water soluble sodium or potassium salts of fatty acids produced by either the saponification of fats and oils, or the neutralization of fatty acid); soapbark (Quillaja saponin); soapstone; sodium acetate; sodium alginate; sodium benzoate; sodium bicarbonate; sodium carboxymethyl cellulose; sodium chloride; sodium citrate; sodium humate; sodium lauryl sulfate; sodium oleate; sodium ricinoleate; sodium stearate; sodium sulfate; sorbitol; soy protein; soya lecithins; soybean hulls; soybean meal; soybean oil; soybean, flour; stearic acid; sulfur; syrups, hydrolyzed starch, hydrogenated; tetragylceryl monooleate; thyme and thyme oil; tricalcium citrate; triethyl citrate; tripotassium citrate; tripotassium citrate monohydrate; trisodium citrate; trisodium citrate dehydrate; trisodium citrate pentahydrate; ultramarine blue; urea; vanillin; vermiculite; vinegar (maximum 8% acetic acid in solution); Vitamin C; Vitamin E; walnut flour; walnut shells; wheat; wheat flour; wheat germ oil; whey; white mineral oil (petroleum); white pepper; wintergreen oil; wollastonite (Ca(SiO₃)); wool; xanthan gum; yeast; Zeolites (excluding erionite (CAS Reg. No. 66733-21-9)); Zeolites, NaA; zinc iron oxide; zinc metal strips (consisting solely of zinc metal and impurities); zinc oxide (ZnO) and zinc stearate.

### Other Aromatics

Formulations of compounds and/or blends of the invention may contain other aromatic compounds or blends. The term “aromatic” as used herein refers to a compound having a distinctive smell or aroma. Such compounds are typically volatile allowing for rapid diffusion into the surrounding air and easily sensed within the olfactory system. One such aromatic compound is cedar oil. Cedar oil may be useful in a given formulation for its ability to both repel insects as well as to kill larvae present in a body of water. Cedar oil formulations may contain from about 0.01% to about 10%, from about 1% to about 5%, from about 2% to about 20% or from about 5% to about 50% cedar oil by weight percent.

Other aromatics that may be included in formulations of compounds and/or blends of the invention include, but are not limited to camphor, pyrethrin and permethrin. Such formulations may contain from about 0.01% to about 10%, from about 1% to about 5%, from about 2% to about 20% or from about 5% to about 50% camphor, pyrethrin and/or permethrin by weight percent.

### Adjuvants

Formulations of compounds and/or blends of the invention may comprise adjuvants. The term “adjuvant”, as used herein refers to any substance that improves or enhances one or more properties of another component within the formulation. Said adjuvants may include, but are not limited to buffers, acidifiers, wetting agents, spreading agents, sticking agents, adhesives, colorants, stabilizers, waterproofing agents, foam retardants and the like.

Formulations with Other Known Agents

Formulations comprising compounds and/or blends of the invention may comprise other compatible active agents known in the art including pesticides, insecticides, bactericides, fungicides, acaricides, microbicides, rodenticides, nematocides, herbicides and the like. The term “bactericide” refers to substances which may destroy or block the growth of bacteria; “fungicide” refers to substances which may destroy or block the growth of fungi; “acaricide” refers to substances which may destroy or block the growth of members of the Arachnida subclass, Acari; “microbicide” refers to substances which may kill or block the growth of microorganisms; “rodenticide” refers to chemical substances which may be capable of killing or blocking the growth of rodents; “nematocide” refers to chemical substances which may be capable of destroying or blocking the growth of nematodes; “herbicide” refers to chemical substances which may be capable of destroying or blocking the growth of plant life.

### Concentrations and Combinations

The compounds and/or blends of the invention may be produced or formulated in various concentrations depending upon the desired application, desired effect and/or type of surface or area that they will be applied to.

Typically compounds and/or blends within a given formulation will be present at a concentration of at least about 0.0001% by weight. In another embodiment, compounds and/or blends may be present at a concentration from about 0.001% to about 0.01%, from about 0.001% to about 0.02%, from about 0.001% to about 0.03%, from about 0.001% to about 0.04%, from about 0.001% to about 0.05%, from about 0.001% to about 0.06%, from about 0.001% to about 0.07%, from about 0.001% to about 0.08%, from about 0.001% to about 0.09%, from about 0.001% to about 0.10%, from about 0.001% to about 0.11%, from about 0.001% to about 0.12%, from about 0.001% to about 0.13%, from about 0.001% to about 0.14%, from about 0.001% to about 0.15%, from about 0.001% to about 0.16%, from about 0.001% to about 0.17%, from about 0.001% to about 0.18%, from about 0.001% to about 0.19%, from about 0.001% to about 0.20%, from about 0.001% to about 0.21%, from about 0.001% to about 0.22%, from about 0.001% to about 0.23%, from about 0.001% to about 0.24%, from about 0.001% to about 0.25%, from about 0.001% to about 0.26%, from about 0.001% to about 0.27%, from about 0.001% to about 0.28%, from about 0.001% to about 0.29%, from about 0.001% to about 0.30%, from about 0.001% to about 0.31%, from about 0.001% to about 0.32%, from about 0.001% to about 0.33%, from about 0.001% to about 0.34%, from about 0.001% to about 0.35%, from about 0.001% to about 0.36%, from about 0.001% to about 0.37%, from about 0.001% to about 0.38%, from about 0.001% to about 0.39%, from about 0.001% to about 0.40%, from about 0.001% to about 0.41%, from about 0.001% to about 0.42%, from about 0.001% to about 0.43%, from about 0.001% to about 0.44%, from about 0.001% to about 0.45%, from about 0.001% to about 0.46%, from about 0.001% to about 0.47%, from about 0.001% to about 0.48%, from about 0.001% to about 0.49%, from about 0.001% to about 0.50%, from about 0.1% to about 1.0%, from about 0.1% to about 1.5%, from about 0.1% to about 2.0%, from about 0.1% to about 2.5%, from about 0.1% to about 3.0%, from about 0.1% to about 3.5%, from about 0.1% to about 4.0%, from about 0.1% to about 4.5%, from about 0.1% to about 5.0%, from about 0.1% to about 5.5%, from about 0.1% to about 6.0%, from about 0.1% to about 6.5%, from about 0.1% to about 7.0%, from about 0.1% to about 7.5%, from about 0.1% to about 8.0%, from about 0.1% to about 8.5%, from about 0.1% to about 9.0%, from about 0.1% to about 9.5%, from about 0.1% to about 10.0%, from about 0.1% to about 10.5%, from about 0.1% to about 11.0%, from about 0.1% to about 11.5%, from about 0.1% to about 12.0%, from about 0.1% to about 12.5%, from about 0.1% to about 13.0%, from about 0.1% to about 13.5%, from about 0.1% to about 14.0%, from about 0.1% to about 14.5%, from about 0.1% to about 15.0%, from about 0.1% to about 15.5%, from about 0.1% to about 16.0%, from about 0.1% to about 16.5%, from about 0.1% to about 17.0%, from about 0.1% to about 17.5%, from about 0.1% to about 18.0%, from about 0.1% to about 18.5%, from about 0.1% to about 19.0%, from about 0.1% to about 19.5%, from about 0.1% to about 20.0%, from about 1% to about 5%, from about 1% to about 10%, from about 1% to about 15%, from about 1% to about 20%, from about 1% to about 25%, from about 1% to about 30%, from about 1% to about 35%, from about 1% to about 40%, from about 1% to about 45%, from about 1% to about 50%, from about 1% to about 55%, from about 1% to about 60%, from about 1% to about 65%, from about 1% to about 70%, from about 1% to about 75%, from about 1% to about 80%, from about 1% to about 85%, from about 1% to about 90%, from about 1% to about 95%, from about 1% to about 100%, from about 10% to about 20%, from about 10% to about 30%, from about 10% to about 40%, from about 10% to about 50%, from about 10% to about 60%, from about 10% to about 70%, from about 10% to about 80%, from about 10% to about 90%, or from about 10% to about 100% by weight. In some cases, formulations of the present invention may comprise 47.5% of two components and 5% of a third component. Additionally, compounds may be combined in various embodiments such that blends and/or formulations of the present invention may comprise 2, 3, 4, 5, 6, 7, 8, 9, 10, 11, 12, 13, 14, 15, 16, 17, 18, 19, 20 or more active compounds.

Units of measure used herein embrace standard units as well as metric units. It is to be understood that where compounds or blends are measured, formulated or packaged in liquid form, the units may be in increments of ounces, cups, pints, quarts, gallons, barrels, or portions thereof. They may also be in metric increments of milliliters, cubic centimeters, deciliters, liters, cubic meters or portions thereof

It is to be understood that where compounds and blends are measured, formulated or packaged as solids, the units may have increments of ounces, pounds, tons, or portions thereof. They may also comprise increments of milligrams, grams, kilograms, metric tons or portions thereof.

Coverage, as it relates to the effective surface or area where bed bug behavior may be modified in response to application of a compound or blend of the invention, may be expressed in inches, feet, square feet, yards, square yards, acres, square acres, or portions thereof. They may also be in increments of millimeters, square millimeters, centimeters, square centimeters, meters, square meters, hectares, kilometers, square kilometers or portions thereof.

### Methods of Application or Treatment

Compounds and/or compositions of the invention may be used to modify pest (e.g. bed bug) behavior in a given area or within the vicinity of a subject or structure. Human and non-human animal subjects may benefit from such use. As used herein, the term “subject” refers to any organism, human or non-human. Non-human animals may include, but are not limited to dogs, cats, mice, rats, rabbits, horses, cattle, sheep, goats, pigs, rodents, chickens, etc.

Many methods of application are known in the art that would be convenient for applying compounds or blends of the present invention to a desired object, individual, surface, area or region. Such methods include, but are not limited to aerosolizing, dusting, vaporizing, misting, spraying, spreading, broadcasting, spackling, sprinkling, painting, brushing, coating, rolling, banding, side-dressing, mopping, bathing, soaking, dipping, immersing, sticking, adhering, wiping, rubbing, impregnating, embedding, injecting, sealing, dotting, dabbing, stippling, layering, stenciling, stamping, pouring and the like. In some embodiments, bed bugs may be exposed to compounds and/or blends of the present invention on or around the surface of a wick that draws from a solution comprising compounds and/or blends of the present invention.

Methods of application may rely on indirect methods of dispersion. In one embodiment, the compound or blend may be left in an area where it may be dispersed by active forces of nature such as wind, rain, sunlight, water current and the like. In another embodiment, a mechanical device may be used to effect the applications listed herein. In a further embodiment, said mechanical device is a timed spreader or broadcaster, set up in predetermined areas in order to apply or disperse the compound or blend to a surface, area or substrate in a temporal fashion. Said mechanical devices may be automated or initiated remotely to apply compounds or blends of the invention.

In some embodiments, compounds and/or compositions of the invention may be used as part of a repellent product. Repellent products of the invention may be used to promote public health by reducing insect-borne illness or disease. In some cases, repellent products may be used to prevent nuisances associated with bed bugs. In some cases, repellent products may be used to protect an indoor area. Such indoor areas may include areas where 1 or more people are protected (e.g. from about 1 to about 3 people, from about 2 to about 4 people, from about 4 to about 10 people, from about 5 to about 50 people or more than 50 people.)

In some embodiments, repellent products of the invention are designed to prevent pests from entering a certain radius centering on a subject or group of subjects. In some cases, such a radius is from about 0 m to 10 m, from about 10 m to about 100 m, from about 50 m to about 200 m or greater than 200 m.

In some embodiments, repellent products of the invention may provide protection for about 1 to about 5 hours, from about 2 to about 10 hours, from about 6 to about 12 hours, from about 3 to about 30 hours, from about 4 to about 40 hours, from about 15 to about 50 hours or for more than 50 hours.

In some embodiments, compounds and/or compositions of the invention may be used as part of an attractant product. Attractant products of the invention may be used in combination with one or more traps. In some cases, such attractant products may be used for bed bug control or surveillance.

### Assays and Testing

Compounds and/or blends of the present invention may be developed in conjunction with assays and/or testing to determine the effectiveness of such compounds and/or blends or derivatives thereof. In some embodiments, testing is carried out to determine the effect of compounds and/or blends of the present invention on bed bug behavior. Such testing may be used to determine the ability of compounds and/or blends of the present invention to act as attractants or repellents.

In some embodiments, spatial experiments are carried out to determine the effect of compounds and/or blends of the present invention on pest behavior (e.g. bed bug behavior). Such spatial experiments comprise the use of one or more spatial arenas. As used herein, the term “spatial arena” refers to any enclosed space. Such arenas may range in size from 2 inch³ to large arenas (including but not limited to semi-field chambers) of about 10,000 ft³. Materials used to enclose spatial arenas may vary depending upon the desired application. Materials may comprise one or more of plastic, plastic sheets, cloth, glass, netting, wood, sheetrock, fiberglass, screening, metal and the like. Spatial arenas may also be climate controlled. In such arenas, one or more of heat, light, humidity and air circulation may be controlled to limit experimental variation and/or simulate a given environment. Bed bug behaviors that may be observed during spatial experiments include, but are not limited to movement toward or away from a given agent, changes in movement level, immobilization, erratic movements and/or death.

In some embodiments, field testing is carried out to test compounds and/or blends of the present invention. As used herein, the term “field testing” refers to testing done in one or more natural environments. Natural environments may include any environments outside of a controlled laboratory environment and is not limited to outdoor sites. Such natural environments may include both indoor and outdoor environments. In some cases, field testing may be carried out in houses or housing complexes. Such housing may include transient housing facilities. Field testing may use traps to collect bed bugs and/or record bed bug numbers at, in or around trap sites.

### Kits

The compounds and/or blends of the present invention may be combined with other ingredients or reagents or prepared as components of kits or other retail products for commercial sale or distribution. These kits and/or formulations may be sold for public use according to the methods disclosed herein. As such the present invention embraces methods of manufacturing or production of kits and or products to be provided to an end-user. Kits may contain packaging, a vial or container comprising the compounds or blends and optionally instructions for use.

Compounds, blends and traps of the present invention may be sold in modular form for assembly, dilution or other method of reconstruction by a subsequent individual or end user as a kit. Said kits may be provided complete with all necessary components to assemble the formulations or traps. In another embodiment, said kits provide a partial number of components necessary and require that the subsequent user or end user provide one or more components separately (such as water or other solvent for dilution, rehydration, etc.)

### Traps

In some embodiments, compounds and/or blends of the present invention may be used as part of a trap. As used herein, the term “trap” refers to any device and/or object used for attracting, capturing and/or killing one or more pests. Traps may be natural or man-made. In some embodiments, traps of the present invention may be passive traps. As used herein, the term “passive trap” refers to a stationary trap that relies on the movement of pests to the trap vicinity. In some embodiments, passive traps may not have moving mechanisms, relying on stationary trap components to immobilize pests and/or prevent their escape from the trap area. In some embodiments, traps may comprise a container (such as a box, cylinder, etc) for collecting pests attracted to the trap. Passive traps may comprise pitfall traps, such as any of those disclosed in US Patent Pub No. US 2009/0145020, US 2012/0246998 and US 2011/0225873, the contents of each of which are herein incorporated by reference in their entirety. In some embodiments, traps may comprise a lure or bait for attracting pests to the trap. Such lures may include compounds and/or blends provided herein. Some traps may comprise a source of CO₂ as an additional lure.

In some embodiments, traps may be lethal traps. As used herein, the term “lethal trap” refers to a trap that kills one or more pests captured by such a trap. Such traps may comprise one or more toxic compounds that may be lethal upon exposure to one or more pests (e.g. ingestion, inhalation, etc). In some embodiments, lethal traps kill captured pests by immobilization (e.g. restriction from movement and/or nutritional sources necessary for vitality). In some embodiments, compounds and/or blends of the present invention may be used as biocides to control insects that may be overcrowding a trap and/or a bait or lure present in, on or around a trap.

### Trap Design and Components

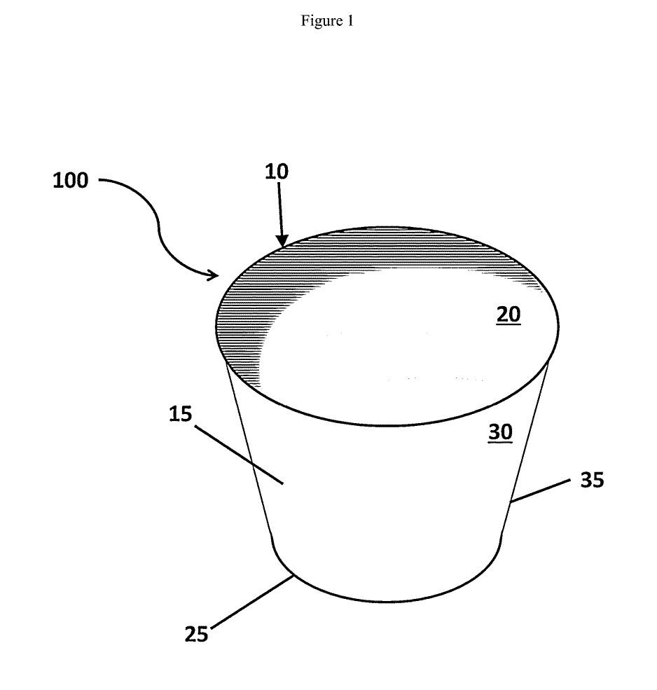

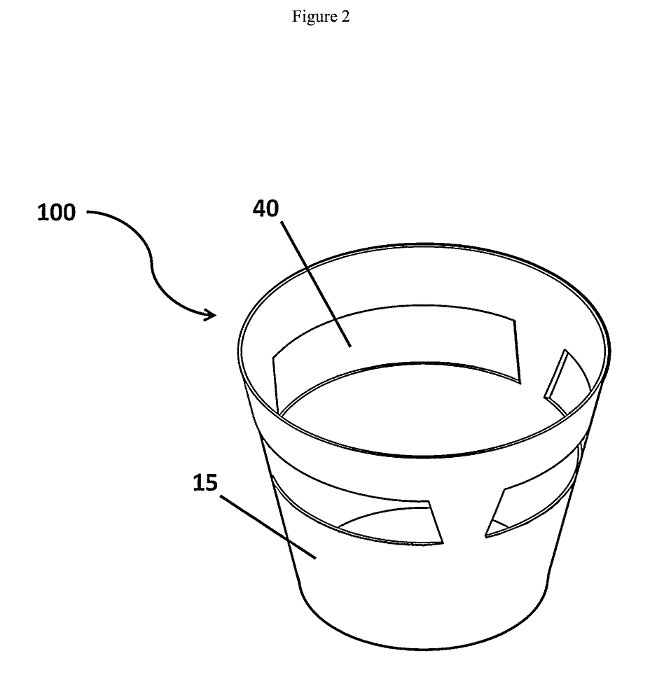

Some traps of the present invention may be used for attracting, capturing and/or killing a variety of pests disclosed herein. Such traps may comprise a bait or lure. Traps capable of attracting, capturing and/or killing bed bugs may comprise a bait or lure and/or take advantage of bed bugs natural instinct to seek harborage. FIG. 1 depicts one embodiment of a trap 100 with a cup-like structure with a rim 10 and a base 25 connected by a trap wall 15. The combination of trap rim 10, base 25 and trap wall 15 is referred to herein as the trap frame 35. The inside area below the rim 10 of the trap is referred to as the “trap well,” where pests become trapped. Trap walls 15 comprise an inner trap surface 20 and an outer trap surface 30. The inner trap surfaces 20 may be smooth to prevent pests from crawling out of trap wells. Turning to FIG. 2, traps 100 may comprise one or more trap windows 40 to allow pests to enter such traps. As referred to herein, a “trap window” is an opening in the trap wall 15. Trap windows may be of any shape, including, but not limited to circular, square, rectangular, triangular, trapezoidal and polygonal. In some embodiments, traps may comprise at least 1, at least 2, at least 3, at least 4, at least 5, at least 6, at least 7, at least 8, at least 9 or at least 10 trap windows.

In some embodiments, the bottom of the inside of the trap may be flat. In some cases, the bottom may be curved (convex or concave) or comprise an irregular surface. This may help to prevent pest escape from such traps.

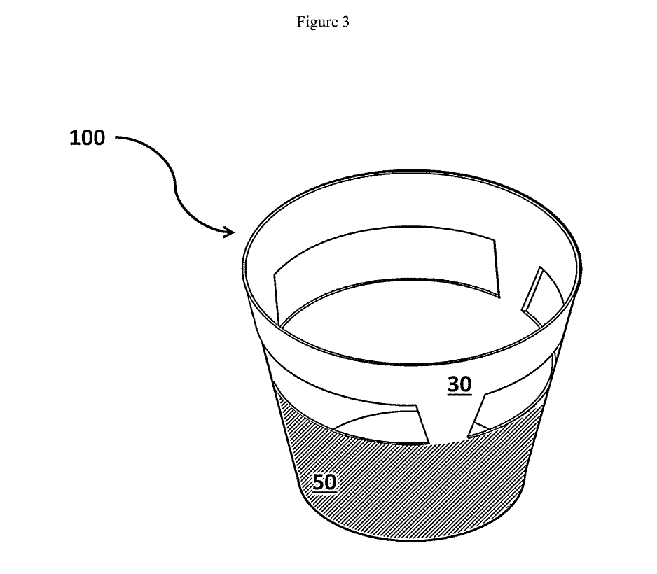

As shown in FIG. 3, outer trap surfaces 30 may comprise climbing surfaces 50 that allow pests, including, but not limited to bed bugs, to climb into the trap 100. Trap climbing surfaces 50 may be textured to facilitate pest climbing. Climbing surfaces 50 that are textured may comprise different materials and/or contours to enable pest climbing. Such materials may include, but are not limited to rubber, foam, sandpaper, filter paper, fabric, netting, screen, textured plastic, etc. In some cases, climbing surfaces may be continuous with trap frames.

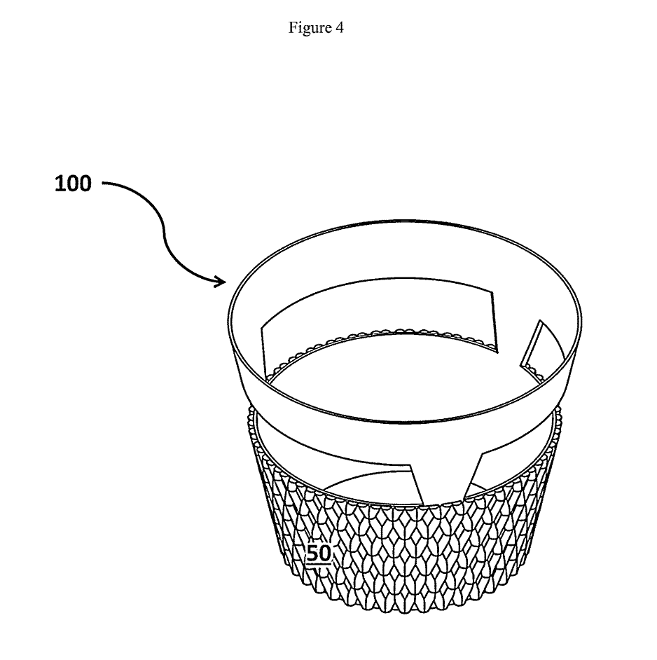

When referring to a climbing surface, the term “contoured,” as used herein, refers to a surface that is irregular, comprising at least one “peak” and at least one “valley” in comparison to a smooth flat and/or rounded surface. Climbing surfaces 50 that are contoured may comprise patterned or random peaks and valleys. When referring to a climbing surface, the term “peak,” as used herein, refers to a high point in the climbing surface and the term “valley,” as used herein, refers to a low point in the climbing surface. Such high and low points are in relation to the overall plane of the surface from the area in which the peak or valley protrudes or descends. As seen in FIG. 4, trap 100 climbing surfaces 50 may be contoured with diamond patterened contours.

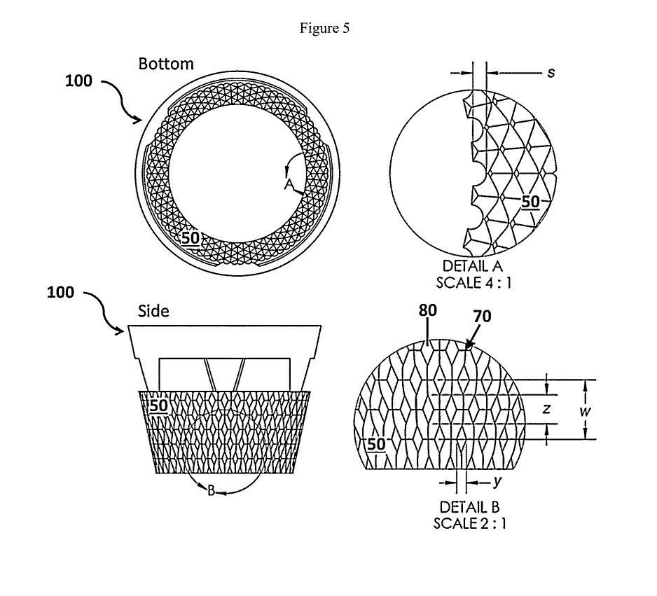

In FIG. 5, the climbing surface 50 of the trap 100 comprises peaks 70 and valleys 80 in the surface. FIG. 5 also depicts bottom and side views of the trap. As shown in the Figure, the depth between the peaks 70 and valleys 80 of the climbing surface 50 may comprise a distance of s, where s may be from about 0.01 to about 0.1, from about 0.05 to about 0.15, from about 0.075 to about 0.2, from about 0.125 to about 0.25 or at least 0.25 inches. Peaks and/or valleys of contors may be pointed, ridged (along a line) or flat. Flat surfaces of peaks and/or valleys may comprise any shape, including, but not limited to circular, square, rectangular, triangular, diamond shaped, trapezoidal and polygonal. Climbing surfaces 50 with diamond patterned contours may comprise flat valleys 80 that comprise diamond shapes as depicted in the side view of FIG. 5. The valleys 80 with diamond-shapes comprise a length z and a width y. In some cases, z may be from about 0.10 inches to about 0.75 inches (including, for example, about 0.2, about 0.25, about 0.3, about 0.35, about 0.4, about 0.45, about 0.5, about 0.55, about 0.6, about 0.65, or about 0.7 inches.) In some cases, z may be from about 0.4 to about 0.45 inches, including, for example about 0.41, about 0.42, about 0.43 or about 0.44 inches. In some cases, y may be from about 0.05 inches to about 0.25 inches (including, for example about 0.1, about 0.15 or about 0.2 inches.) FIG. 5 demonstrates peaks 70 that comprise ridges. Such traps may comprise a distance, w, between adjacent intersecting peak 70 ridges that align vertically. In such cases, w may be from about 0.10 inches to about 1.00 inches (including, for example, about 0.20, about 0.25, about 0.30, about 0.35, about 0.40, about 0.45, about 0.50, about 0.55, about 0.60, about 0.65, about 0.70, about 0.75, about 0.80, about 0.85, about 0.90 or about 0.95 inches.) In some cases, w may be from about 0.85 to about 0.95 inches, including, for example, about 0.86, about 0.87, about 0.88, about 0.89, about 0.90, about 0.91, about 0.92, about 0.93 or about 0.94 inches.

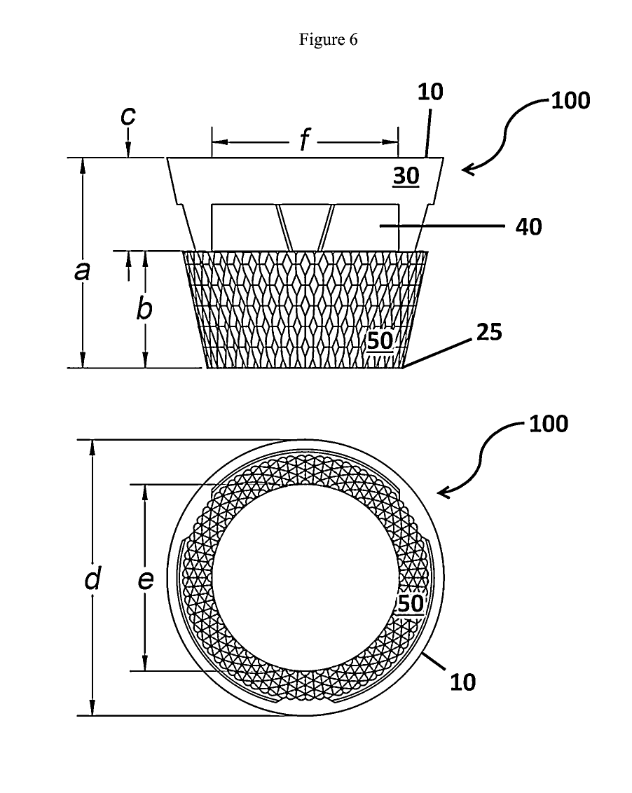

FIG. 6 depicts side and bottom views of a trap with dimensions indicated by a [trap 100 height,] b [climbing surface 50 height,] c [trap 100 height-climbing surface 50 height,] d [trap rim 10 diameter] and e [base 25 diameter.] Trap 100 height, a, may be from about 0.5 inches to about 10 inches, including, about 1.0, about 1.5, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0 or about 9.5 inches. Climbing surface 50 height, b, may be from about 0.5 inches to about 9 inches, including, but not limited to about 1.0, about 1.5, about 2.0, about 2.5, about 3.0, about 3.5, about 4.0, about 4.5, about 5.0, about 5.5, about 6.0, about 6.5, about 7.0, about 7.5, about 8.0 and about 8.5 inches. In some cases, climbing surfaces 50 may cover a certain percentage of the outer trap surface 30. Such climbing surfaces 50 may cover from about 10% to about 100% of outer trap surfaces 30, including at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 90% or at least 95%. c may be at least 0.5 inches, at least 1.0 inch, at least 1.5 inches, at least 2.0 inches, at least 2.5 inches, at least 3.0 inches, at least 3.5 inches, at least 4.0 inches, at least 4.5 inches or at least 5.0 inches. Rim 10 diameter, d, may be from about 1 inch to about 10 inches, including, about 1.5, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0 or about 9.5 inches. In some cases, d may be from about 5.5 to about 6.0 inches, including about 5.6 inches, about 5.7 inches, about 5.8 inches and about 5.9 inches. In some cases, trap rim diameters may be from about 1.0 inches to about 3.0 inches (e.g. about 1.25, about 1.5, about 1.75, about 2.0, about 2.25, about 2.5 or 2.75 inches.) In further embodiments, d is about 5.91, about 5.92, about 5.93, about 5.94, about 5.95, about 5.96, about 5.97, about 5.98 or about 5.99 inches. Base 25 diameter, e, may be from about 0.5 inches to about 10 inches, including, about 1.0, about 1.5, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0 or about 9.5 inches. In some cases, e may be from about 1.0 inches to about 4.0 inches, including, but not limited to from about 1.0 inches to about 2.5 inches, from about 1.5 to about 3.0 inches or from about 2.0 to about 4.0 inches. In some traps, e may be less than d. In other traps e may be greater than d. Such traps may comprise a slope in the climbing surface that may be easier for pests to traverse.

As seen in FIG. 6, trap windows 40 comprise a length, f. This length may be from about 0.5 inches to about 8.0 inches, such as, for example, from about 0.5 to about 2.0, from about 1.0 to about 5, from about 1.5 to about 6.5, from about 2.5 to about about 7.5 or from about 4.0 to about 8.0 inches. Windows may also be from about 0.1 to about 1.5 inches in height (including, for example about 0.2, about 0.3, about 0.4, about 0.5, about 0.6, about 0.7, about 0.8, about 0.9, about 1.0, about 1.1, about 1.2, about 1.3 or about 1.4 inches in height.)

In some embodiments, one or more trap surfaces may be coated. Such coatings may include lubricants. Lubricant coatings may be used on inner trap surfaces to prevent pest traction and climbing of the inner well surface. Further coatings may comprise adhesives. Such adhesives may slow or immobilize pests, capturing pests and/or preventing their escape from traps of the present invention. In some cases, outer trap surfaces may be coated. Such coatings may help to improve pest traction to allow pests to climb into the trap.

Some traps comprising trap windows may lack an opening at the trap rim. In some cases, such traps may comprise a trap lid that covers the opening at the trap rim. As used herein, the term “lid” refers to a removeable cover of a container (e.g. a trap.) Lidded traps may encourage pests to enter such traps through trap windows. Lids may be designed to attach to trap rims according to any methods known in the art. As such lids may be threaded to screw onto traps of the invention. Traps used with such lids may comprise rims that are also threaded to receive the threaded lids. In some cases, lids may comprise a rim structure that enables such lids to engage trap rims by pressing the lid down. In some cases, the rim of traps that may be used with such lids may comprise a lip that engages with the lid rim structure to form a tight bond between the trap and lid. As used herein, the term “lip” refers to the bump that runs the length of an elongated structure (e.g. a rim.) Examples of such lids and/or rim structures may include any of those described in U.S. Pat. Nos. 5,065,880 and/or 8,056,752, the contents of each of which are herein incorporated by reference in their entirety. Some lids may comprise one or more colors and may be opaque, translucent or clear. Lids may be attached by screwing them on, snapping them on or by other means known in the art. Lidded traps with windows may simulate a harborage sought by pests, such as bed bugs. Lidded traps may also promote the escape of lure odors through trap windows (wherein windows comprise the only openings for such odors to escape.) The escape of odors in this manner may enhance the attraction of pests to trap windows, thereby increasing pest killing and/or capture.

Some windows may comprise long and narrow horizontal openings to further simulate crevices and other areas of harborage sought by pests, including, but not limited to bed bugs. Trap window shapes may comprise curved shapes (including but not limited to circles and ovals) or polygons (including but not limited to squares, triangles, trapezoids and rectangles).

Trap surfaces may comprise any color (including, but not limited to red, orange, yellow, green, blue, purple, black or white) or combinations of colors. Inner surface and outer surface trap colors may be different and may or may not comprise patterns (e.g. striped, zig zagged, checkerboard, spotted, camouflaged, etc). In some cases, trap colors may be altered to improve catch rate. In some embodiments of the present invention, the outer surfaces of traps may be blue. In some cases, trap inner surfaces may be white.

As viewed from above, traps may comprise a variety of cross sectional shapes. Such shapes may include, but are not limited to circular, square, rectangular, triangular, polygonal or irregular. Further, traps may be tapered such that trap bases comprise sizes different from trap rims. Such traps may comprise trap rims that are larger than trap bottoms. These traps may include cup-shaped traps, also referred to herein as “high profile” traps.

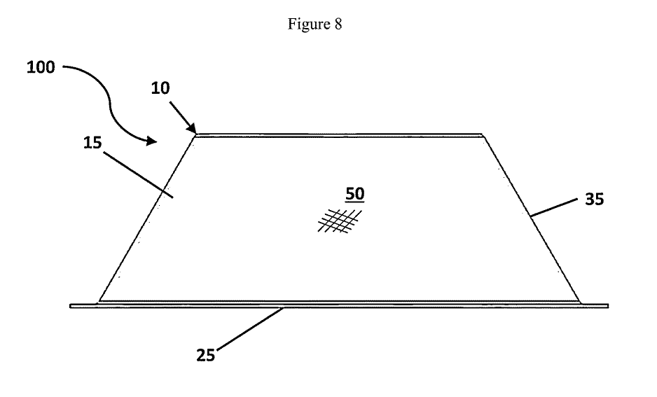

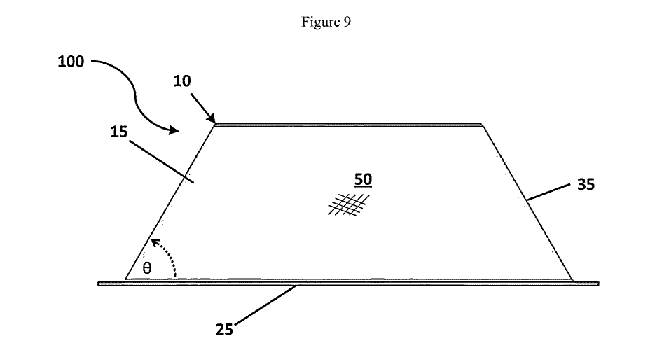

In some cases, trap bases may comprise larger sizes than trap rims, resulting in a tapered trap with trap walls that taper away from the trap center from top to bottom. Such traps are referred to herein as “low profile” traps. An embodiment of a low profile trap is pictured in FIG. 8. FIG. 9 shows the angle “θ” between the trap base 25 and the trap wall 15. θ may comprise any value from about 5° to about 85°, for example, θ may be from about 5° to about 25°, from about 10° to about 50°, from about 15° to about 60°, from about 20° to about 80° or from about 45° to about 85°.

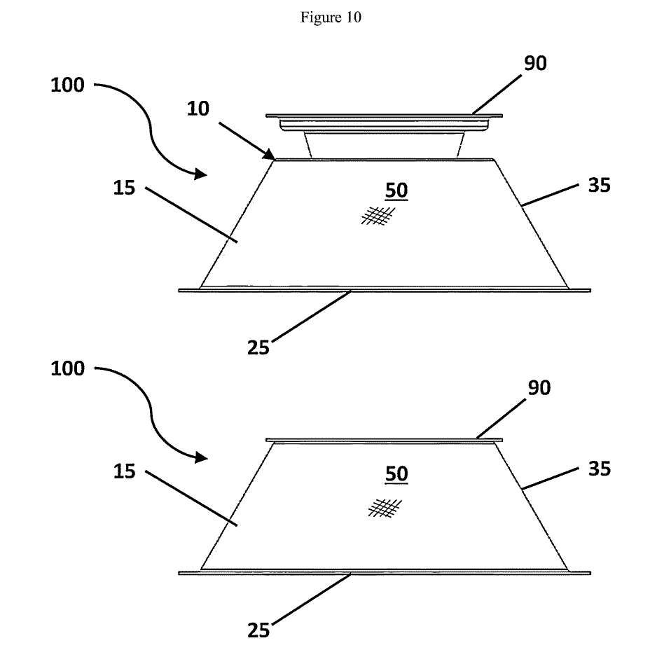

In some embodiments, traps of the invention may comprise a plug lid. As used herein, a “plug lid” refers to a lid with a top portion and a bottom portion wherein the top portion is larger than the trap rim 10 and the bottom portion is smaller than the trap rim 10. The region between the top portion and bottom portion of such lids may be tapered, such that at least one plane of the lid forms a seal with the inner side of the trap rim. In some cases, the top portion of plug lids rest on top of trap rims to form a seal. Plug lids may be solid or hollow. One embodiment of a plug lid 90 is depicted in FIG. 10. FIG. 10 (top) depicts a plug lid 90 above the trap rim 10, while FIG. 10 (bottom) shows the plug lid 90 engaged with the trap 100.

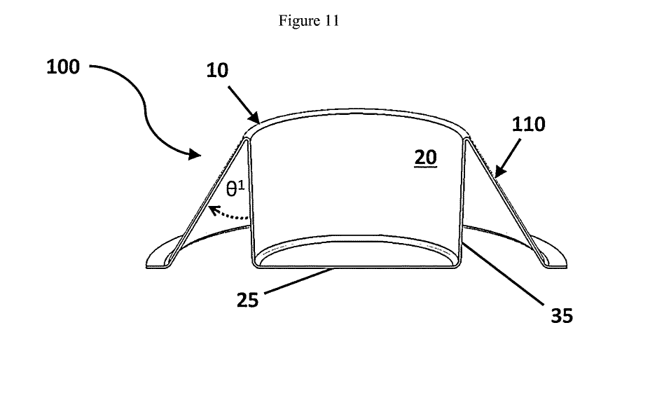

FIG. 11 shows a cross-section of one embodiment of a skirted trap. Skirted traps comprise a skirt layer 110 that starts in contact with the trap rim 10 and tapers outward as it reaches the ground (which may or may not lie in the same plane with the trap base 25.) The skirt layer 110 typically forms a truncated cone shape surrounding the trap frame 35, but in some cases, the skirt layer may form other types of geometric frusta. The skirt layer outer surface typically comprises a climbing surface, such as those described above, to allow bed bugs to ascend the skirt layer and enter the trap. Further skirt layers may comprise channels or grooves to facilitate bed bug climbing. The skirt layer, as shown in FIG. 11, extends away from the trap wall at an angle, θ¹. θ¹ may be any acute angle, including, but not limited to from about 5° to about 85°, for example, θ¹ may be from about 5° to about 30°, from about 10° to about 50°, from about 15° to about 75°, from about 20° to about 80° or from about 45° to about 85°.

In some cases, traps may comprise bait or lures. Such bait or lures may comprise one or more compounds and/or blends of the present invention. Further baits or lures may include any of those described in International Patent Application number PCT/US13/55330, the contents of which are herein incorporated by reference in their entirety. In some cases, luring compounds and/or blends are placed within the trap wells. Such compounds and/or blends may be present in a variety of forms that may include, but are not limited to liquid, solid, gel, paste, etc. Further, luring compounds and/or blends applied to traps may be comprised in or on one or more substrates or matrices, referred to herein as “bait substrates.” Bait substrates may be comprised of any materials including, but not limited to cotton, paper, filter paper, wood, pellets, granules, cloth, etc. Some baited traps may comprise fans or other devices to facilitate diffusion of bait odors, helping to attract pests to the trap.

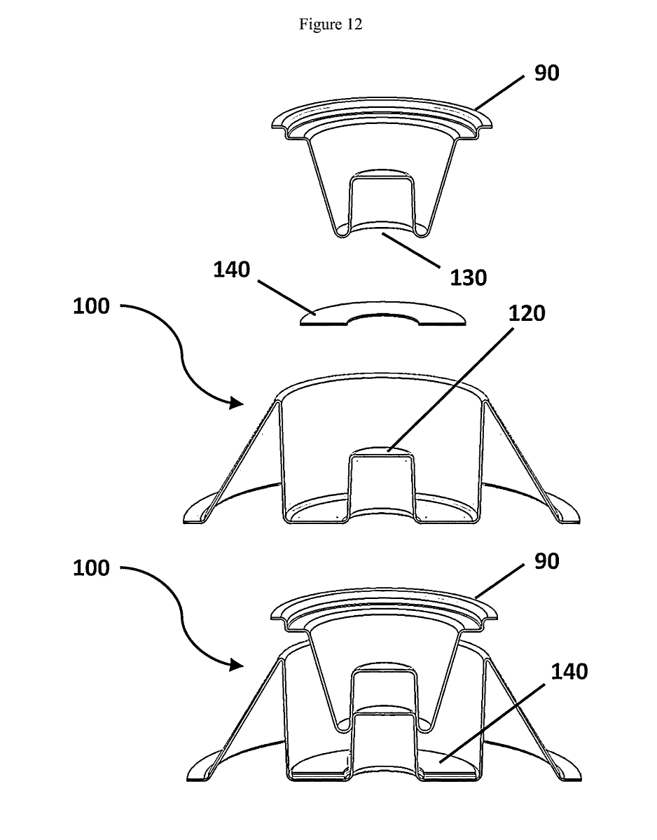

In some embodiments, traps may comprise a base peg 120 extending into the trap center. Base pegs may engage with a base peg sleeve 130 on a plug lid 90. A cross-sectional view of an embodiment of such a trap 100 is depicted in FIG. 12. Frictional force between the base peg 120 and base peg sleeve 130 on the plug lid 90 may hold the plug lid 90 in place and/or allow the plug lid 90 to be raised, while still remaining engaged with the trap and held in place by friction between the base peg 120 and base peg sleeve 130 (see FIG. 12, bottom.) This design creates an opening above the trap rim 10 for bed bugs to enter the trap, while the plug lid 90 creates an overhang that may encourage bed bugs to enter the trap due to their natural instinct to seek harborage. The opening created between the trap rim 10 and the plug lid 90 may comprise a height of from about 0.050 inches to about 0.500 inches, including, but not limited to from about 0.050 inches to about 0.200 inches, from about 0.075 inches to about 0.250 inches, from about 0.100 inches to about 0.300 inches, from about 0.150 inches to about 0.450 inches or from about 0.350 inches to about 0.500 inches. In some cases, friction between the base peg 120 and base peg sleeve 130 may allow this height to be adjustable, to allow for optimization by a user.

In some cases, such traps may comprise a bait substrate 140 comprising a washer-shape as is depicted in FIG. 12 (cross-sectional view), that fits around the base peg 120.

In some cases, traps (not including trap lids) may comprise a single piece. Such traps may be manufactured using a mold or in some cases, may be constructed by three-dimensional printing. Trap frames and/or other trap parts may be comprised of a variety of materials or combinations of materials. Such materials may include, but are not limited to paper, plastics, wood, metal, polymeric materials, polyethylene, polypropylene, rubber, cellulose, silicon rubber, styrofoam and cellulose-based materials. In some cases, traps may be comprised of polyethylene terephthalate (PET.) The thickness of materials making up trap frames and/or other trap parts may be from about 0.001 inches to about 0.20 inches. Trap frame thicknesses, for example, may be from about 0.001 to about 0.05, from about 0.02 to about 0.10 or from about 0.07 to about 0.20 inches thick. In some cases, trap frames may be at least 0.20 inches thick. In some cases, trap frames may be from about 0.015 to about 0.20 inches thick.

Traps of the present invention may be placed in areas known or suspected to comprise one or more pests. Such areas may include, but are not limited to outdoor areas, dwellings or other structures, rooms within a dwelling or structure and/or one or more regions within a room. Traps may be placed on the ground or one or more elevated surfaces where pests are thought to live or be able to climb to. In some cases, traps may be deployed without bait or lures. Such traps may rely on natural pest instincts to seek harborage, such is the case with bed bugs. Traps deployed in such a manner may be used to determine whether one or more pest types are inhabiting a given area of deployment.

Some traps of the present invention may be designed or disguised to keep observers from immediately recognizing them as pest traps. Such traps may be designed or disguised to imitate items that may include, but are not limited to decorative stands, plant holders, balls, candles, lanterns and lamps.

### Devices

In some embodiments, compounds and/or blends of the present invention may be used in conjunction with devices to house, contain and/or facilitate diffusion of such compounds and/or blends. Such devices may include decorative stands, balls, sticks (such sticks comprising of materials that may include, but are not limited to cellulose, plastic, wood, paper and the like), coils, paints, fabrics, patches, cattle/animal ear tags, bed nets, infused plastics, foggers, candles, lanterns, lamps, clip-on devices and plug-in devices (with or without air diffusers.) Such devices may comprise compounds and/or blends of the present invention in liquid and/or solid state forms. In some embodiments, such devices may be capable of being refilled.

### Spray Bottles

In some embodiments, compounds and/or blends of the present invention may be comprised in a spray bottle. Spray bottles may be used to apply liquid solutions of compounds and/or blends of the present invention to subjects, objects and/or other materials. Spray bottles may include, but are not limited to pump spray bottles, compressed air spray bottles and aerosol spray bottles.

### Patches

In some embodiments, formulations comprising compounds of the present invention may be applied to or incorporated within a patch. As used herein, the term “patch” refers to a small piece of material. Patches may act as matrices that hold compounds and/or blends of the present invention. Patches that have been applied with or infused with formulations of the present invention may be used to modify the behavior of pests that come within a given vicinity of such patches, in some embodiments, acting as a spatial repellent.

Compounds and/or blends of the present invention may be applied to patches in liquid format or formulation. In some cases, patches are used while such liquid formulations are still wet, while in other embodiments, liquid formulations are allowed to dry. Patches of the present invention may comprise any of a number of materials including, but not limited to paper, plastic, metal, fabric, wax, polymeric materials, polyethylene, polypropylene, rubber, cellulose, silicon rubber and/or cellulose-based materials. Some patches are designed to be water-resistant or water-proof

Patches may be of various sizes and shapes. In some embodiments, patches are flat and comprise an area of from about 1 cm² to about 5 cm², from about 2 cm² to about 10 cm², from about 3 cm² to about 15 cm², from about 4 cm² to about 20 cm², from about 12 cm² to about 48 cm², from about 24 cm² to about 72 cm², from about 50 cm² to about 100 cm² or at least 100 cm². Patch shapes may include, but are not limited to circles, squares, rectangles, triangles and polygons. In some embodiments, patches are square with side lengths of about 1.5 cm. Additionally, patches may comprise any color and or pattern. Non-limiting examples of patch colors include red, orange, yellow green, blue, purple, indigo, violet, black, white, fluorescent, etc. Non-limiting examples of patch patterns include striped, checkerboard patterned, spotted, dotted, speckled, camouflaged, etc.

Patches may be applied to subjects according to any methods known to those of skill in the art. Such methods may include, but are not limited to direct application to subject skin, clothing or apparel (e.g. accessory items, hats, backpacks, scarfs, gloves, shoes, sunglasses, ear rings, etc.) Patches may be associated with such skin, clothing or apparel through adhesives (e.g. glues, pastes, gels, resins, gums, epoxies, etc.), static electrical interactions, tape, banding (such as attachment using a wrist, leg and/or waste band) or through other methods known in the art. Some adhesives that may be used may be water-resistant or water-proof adhesives. Some patches comprise a film or paper layer to protect patch adhesives. Such film or paper layers may be peeled off prior to application of such patches.

In some cases, patches may be placed around areas of bed bug infestation or potential infestation to repel bed bugs. Such patches may be designed such that they do not stain fabrics and/or carpets to which they are applied, or leave any residual odors upon removal of such patches. Some patches may be placed inside or attached to a holder. As used herein, the term “holder” refers to a container or device used to house and/or grasp a patch. Holders may comprise pockets, compartments, cassettes, boxes, clips or other such devices that may be used to house or bind a patch. Some holders may comprise materials including, but not limited to metal, plastic, elastic, mesh, screen, fabric and/or wood. Holders may vary in size to accommodate home or outdoor uses.

Some patches and/or holders may be attached to subjects using accessory devices. As used herein, the term “accessory device” refers to a device of secondary importance in relation to a first device. In some embodiments, accessory devices may comprise something that is worn to attach patches and/or holders to a subject. Such accessory devices may include, but are not limited to bracelets, necklaces, wrist bands, collars, arm bands, clothing, fabric and/or clip-on devices. In some embodiments accessory devices may comprise air diffusers. As used herein, the term “air diffuser” refers to a device that circulates air, allowing for the spreading and/or dissipation of aerosols. Such air diffusers may be powered (e.g. battery powered, solar powered, etc.) or un-powered. Some air diffusers may comprise a fan. Air diffusers may be used to disperse compounds and/or blends comprised in patches, creating a greater zone of protection.

In some embodiments, patches may be used to protect non-human animal subjects, including, but not limited to cats, pigs, dogs, horses and cattle. Patches may be associated with such animals through an accessory device, non-limiting examples of which may include collars or bands. In other embodiments, patches are placed within a holder that is worn around the neck or other body part of such animals.

### EQUIVALENTS AND SCOPE

Those skilled in the art will recognize, or be able to ascertain using no more than routine experimentation, many equivalents to the specific embodiments in accordance with the invention described herein. The scope of the present invention is not intended to be limited to the above Description, but rather is as set forth in the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

It is also noted that the term “comprising” is intended to be open and permits but does not require the inclusion of additional elements or steps. When the term “comprising” is used herein, the term “consisting of” is thus also encompassed and disclosed.

Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise.

Where the term “about” is used, it is understood to reflect+1-10% of the recited value.

In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein. Any particular embodiment of the compositions of the invention (e.g., any method of production; any method of use; etc.) can be excluded from any one or more claims, for any reason, whether or not related to the existence of prior art.

All cited sources, for example, references, publications, databases, database entries, and art cited herein, are incorporated into this application by reference, even if not expressly stated in the citation. In case of conflicting statements of a cited source and the instant application, the statement in the instant application shall control.

Section and table headings are not intended to be limiting.

### EXAMPLES

### Example 1. Bed Bug Repellency Assay

Compounds and blends of the present invention were assayed for their ability to modify bed bug (Cimex lectularius) behavior using a bed bug repellency assay. This assay takes advantage of the bed bug's natural instinct to seek harborage. Two petri dishes were obtained and the inner areas of each were sanded down (leaving the perimeter smooth.) Talc was applied on the perimeter and on the inside walls of the petri dishes with a small paint brush to prevent bed bugs from escaping. A cut off top portion of a plastic cup was placed upside down in the center of one petri dish to create a holding arena for the bed bugs. A large plastic secondary container was gathered and a paper towel was laid down inside the bottom. The petri dish was then placed inside and ten bed bugs were placed inside the cut off portion of the cup.

Next, two pieces of filter paper were cut down the middle to yield 4 equally sized halves. Three pieces were placed inside a glass dish (100 cm×50 cm or 90 cm×50 cm) and the remaining piece was placed in a separate dish. All four pieces were folded down the middle to create a “tent” or “harborage” when laid such that the folded crease faced up. 100 microliters of isopropyl alcohol was pipetted into three pieces of filter paper (all housed in the first glass dish.) In a separate 4 ml vial, 90 microliters of isopropyl alcohol was combined and vortexed with 10 microliters of the compound or compound combination being tested. 100 microliters of this solution [comprising a total of 100 mg of compound(s)] was pipetted onto the filter paper in the separate dish. All filter papers were then allowed to dry. Once dry, experiments were conducted first with two filter paper halves comprising only the isopropyl alcohol (control experiment) and then with the remaining filter paper halves [one with only isopropyl alcohol and one comprising the test compound(s).] Filter paper halves were placed on opposing sides of experimental petri dishes and bed bugs were allowed to move freely within the dishes by removal of the plastic cup top. Movement was allowed to continue for 5 minutes before the number bed bugs beneath each filter paper tent was recorded. Data obtained for each individual compound tested is listed in Table 3. Percent repellency represents the percentage of bed bugs that did not move beneath treated filter paper tents as compared to control.

TABLE 3
Bed bug repellency for individual compounds

| Compound | % | Repellency |
|---|---|---|
| No. | Repellency | Category |
| BBC001 | 100 | Very Strong |
| BBC002 | 100 | Very Strong |
| BBC003 | 100 | Very Strong |
| BBC004 | 100 | Very Strong |
| BBC005 | 100 | Very Strong |
| BBC006 | 100 | Very Strong |
| BBC007 | 100 | Very Strong |
| BBC008 | 100 | Very Strong |
| BBC009 | 100 | Very Strong |
| BBC010 | 100 | Very Strong |
| BBC011 | 100 | Very Strong |
| BBC012 | 100 | Very Strong |
| BBC013 | 90 | Very Strong |
| BBC014 | 87 | Very Strong |
| BBC015 | 86 | Very Strong |
| BBC016 | 84 | Very Strong |
| BBC017 | 82 | Very Strong |
| BBC018 | 77 | Strong |
| BBC019 | 72 | Strong |
| BBC020 | 71 | Strong |
| BBC021 | 71 | Strong |
| BBC022 | 70 | Strong |
| BBC023 | 68 | Strong |
| BBC024 | 60 | Strong |
| BBC025 | 60 | Strong |
| BBC026 | 59 | Moderate |
| BBC027 | 59 | Moderate |
| BBC028 | 59 | Moderate |
| BBC029 | 56 | Moderate |
| BBC030 | 54 | Moderate |
| BBC031 | 50 | Moderate |
| BBC032 | 49 | Moderate |
| BBC033 | 49 | Moderate |
| BBC034 | 47 | Moderate |
| BBC035 | 44 | Moderate |
| BBC036 | 41 | Moderate |
| BBC037 | 41 | Moderate |
| BBC038 | 39 | Mild |
| BBC039 | 38 | Mild |
| BBC040 | 37 | Mild |
| BBC041 | 37 | Mild |
| BBC042 | 35 | Mild |
| BBC043 | 33 | Mild |
| BBC044 | 29 | Mild |
| BBC045 | 24 | Mild |
| BBC046 | 23 | Mild |
| BBC047 | 22 | Mild |
| BBC048 | 21 | Mild |
| BBC049 | 20 | Mild |
| BBC050 | 20 | Mild |

Compounds were divided into mild, moderate, strong and very strong repellent categories based on the results. Compounds with a percent repellency value of 20-40% were categorized as mild repellents. Compounds with a percent repellency value of 40-60% were categorized as moderate repellents. Compounds with a percent repellency value of 60-80% were categorized as strong repellents and compounds with a percent repellency value of 80-100% were categorized as very strong repellents.

Blends of compounds were also tested. Percent repellency values for blends tested are presented in Table 4.

TABLE 4
Bed bug repellency for blends

| Blend | % | Repellency |
|---|---|---|
| No. | Repellency | Category |
| BBB001 | 100 | Very Strong |
| BBB002 | 100 | Very Strong |
| BBB003 | 100 | Very Strong |
| BBB004 | 100 | Very Strong |
| BBB005 | 100 | Very Strong |
| BBB006 | 100 | Very Strong |
| BBB007 | 100 | Very Strong |
| BBB008 | 100 | Very Strong |
| BBB009 | 100 | Very Strong |
| BBB010 | 100 | Very Strong |
| BBB011 | 100 | Very Strong |
| BBB012 | 100 | Very Strong |
| BBB013 | 100 | Very Strong |
| BBB014 | 100 | Very Strong |
| BBB015 | 100 | Very Strong |
| BBB016 | 100 | Very Strong |
| BBB017 | 100 | Very Strong |
| BBB018 | 100 | Very Strong |
| BBB019 | 100 | Very Strong |
| BBB020 | 100 | Very Strong |
| BBB021 | 100 | Very Strong |
| BBB022 | 100 | Very Strong |
| BBB023 | 100 | Very Strong |
| BBB024 | 100 | Very Strong |
| BBB025 | 100 | Very Strong |
| BBB026 | 100 | Very Strong |
| BBB027 | 100 | Very Strong |
| BBB028 | 100 | Very Strong |
| BBB029 | 100 | Very Strong |
| BBB030 | 95 | Very Strong |
| BBB031 | 92 | Very Strong |
| BBB032 | 92 | Very Strong |
| BBB033 | 91 | Very Strong |
| BBB034 | 91 | Very Strong |
| BBB035 | 91 | Very Strong |
| BBB036 | 91 | Very Strong |
| BBB037 | 89 | Very Strong |
| BBB038 | 89 | Very Strong |
| BBB039 | 89 | Very Strong |
| BBB040 | 88 | Very Strong |
| BBB041 | 88 | Very Strong |
| BBB042 | 88 | Very Strong |
| BBB043 | 87 | Very Strong |
| BBB044 | 86 | Very Strong |
| BBB045 | 85 | Very Strong |
| BBB046 | 84 | Very Strong |
| BBB047 | 81 | Very Strong |
| BBB048 | 79 | Strong |
| BBB049 | 79 | Strong |
| BBB050 | 78 | Strong |
| BBB051 | 78 | Strong |
| BBB052 | 76 | Strong |
| BBB053 | 75 | Strong |
| BBB054 | 74 | Strong |
| BBB055 | 73 | Strong |
| BBB056 | 72 | Strong |
| BBB057 | 72 | Strong |
| BBB058 | 72 | Strong |
| BBB059 | 71 | Strong |
| BBB060 | 67 | Strong |
| BBB061 | 66 | Strong |
| BBB062 | 65 | Strong |
| BBB063 | 63 | Strong |
| BBB064 | 63 | Strong |
| BBB065 | 60 | Strong |
| BBB066 | 59 | Moderate |
| BBB067 | 58 | Moderate |
| BBB068 | 56 | Moderate |
| BBB069 | 55 | Moderate |
| BBB070 | 53 | Moderate |
| BBB071 | 52 | Moderate |
| BBB072 | 51 | Moderate |
| BBB073 | 51 | Moderate |
| BBB074 | 46 | Moderate |
| BBB075 | 46 | Moderate |
| BBB076 | 43 | Moderate |
| BBB077 | 43 | Moderate |
| BBB078 | 41 | Moderate |
| BBB079 | 40 | Moderate |
| BBB080 | 40 | Moderate |
| BBB081 | 37 | Mild |
| BBB082 | 35 | Mild |
| BBB083 | 29 | Mild |
| BBB084 | 27 | Mild |
| BBB085 | 27 | Mild |
| BBB086 | 26 | Mild |
| BBB087 | 22 | Mild |
| BBB088 | 22 | Mild |
| BBB089 | 21 | Mild |

Blends were divided into mild, moderate, strong and very strong repellent categories based on the results. Blends with a percent repellency value of 20-40% were categorized as mild repellents. Blends with a percent repellency value of 40-60% were categorized as moderate repellents. Blends with a percent repellency value of 60-80% were categorized as strong repellents and blends with a percent repellency value of 80-100% were categorized as very strong repellents.

### Example 2. Bed Bug Luring Assay

Assays were conducted to measure the ability of compounds and compound combinations to attract bed bugs. A testing arena habitat comprising a small plastic container was placed inside of a larger, secondary container. The top half inch was removed from two bathroom sized plastic cups and each cup was placed on opposite sides of the testing arena habitat, one inch away from the wall. Each outer part of the cup was textured using sandpaper, as bed bugs cannot climb smooth surfaces. A paper towel was used to line the floor of the testing arena habitat. The top, removed portion of one of the cups was placed mouth side down in the center of the arena. In one of the cups, a cottonball was placed and treated with 100 microliters of compound or compound combination solution [comprising a total of 100 mg of compound(s).] Ten bed bugs were placed within the center cut off cup top and the testing arena habitat was covered and placed within a dark, climate controlled room overnight.

The next day, the number of bed bugs that crawled into the baited cup were recorded and the attractant activity value was calculated. As used herein, the attractant activity value represents the percentage of bugs that crawled into the baited cup as compared to the total number of bed bugs. The data obtained for each compound or blend tested is presented in Table 5. In the Table, “Att Act” refers to attract activity value. Some compounds and combinations comprising ethyllactate and/or cyclopentanone displayed surprisingly strong ability to attract bed bugs.

TABLE 5
Bed bug attractant activity

| Compound/Blend | | Attractant |
|---|---|---|
| No. | Att Act | Category |
| BBC069 | 50% | Strong |
| BBC035 | 30% | Moderate |
| BBC047 | 30% | Moderate |
| BBC065 | 30% | Moderate |
| BBC070 | 30% | Moderate |
| BBC039 | 20% | Moderate |
| BBC060 | 20% | Moderate |
| BBC049 | 10% | Mild |
| BBC051 | 10% | Mild |
| BBC067 | 10% | Mild |
| BBB102 | 80% | Very Strong |
| BBB103 | 50% | Strong |
| BBB086 | 40% | Strong |
| BBB104 | 40% | Strong |
| BBB105 | 40% | Strong |
| BBB106 | 40% | Strong |
| BBB072 | 30% | Moderate |
| BBB120 | 30% | Moderate |
| BBB028 | 20% | Moderate |
| BBB058 | 20% | Moderate |
| BBB078 | 20% | Moderate |
| BBB080 | 20% | Moderate |
| BBB107 | 20% | Moderate |
| BBB052 | 10% | Mild |
| BBB053 | 10% | Mild |
| BBB085 | 10% | Mild |
| BBB091 | 10% | Mild |
| BBB108 | 10% | Mild |
| BBB109 | 10% | Mild |

Compounds or blends with an attractant activity value of 10-20% were categorized as mild attractants. Compounds or blends with an attractant activity value of 20-40% were categorized as moderate attractants. Compounds or blends with an attractant activity value of 40-60% were categorized as strong attractants. Compounds or blends with an attractant activity value of >60% were categorized as very strong attractants.

### Example 3. Large Arena Bed Bug Repellency Testing

Compounds and blends were tested using large arena testing. Large arena testing was carried out to measure repellent efficacy and distance for putative repellents when challenged against the harborage instinct. Assays were conducted in a 24.5 inch×14.5 inch×6 inch plastic container with a 4 inch×4 inch piece of black heavy duty construction paper, folded in an accordion shape, placed at the center, serving as the harborage. The lid of a 150 mm petri dish (VWR International, Radnor, Pa.) with the center cut out served as a holding arena around the harborage to keep the bed bugs confined once they were introduced into the tub. Ten bed bugs were then placed on the harborage and given 10 minutes to condition to the experimental setting. Once conditioned, one-half of a piece of 55 mm Whatman filter paper (Fisher Scientific, Waltham, Mass.) was impregnated with a 50% (volume/volume or weight/volume) solution of individual compounds or blends diluted in isopropyl alcohol was placed on the harborage. The holding arena was removed and the assay was conducted over a 20 minute period. A high definition camcorder (Panasonic HDC-HS900) was set-up above the assay arena for time lapse photography of the experiment. Once the assay was complete, the recordings were downloaded and the number of bed bugs no longer in harborage were counted at the 5, 10, 15 and 20 minute time points. Experiments were conducted in triplicate. Average values were used to calculate repellency according to the formula: large arena percent repellency=(1-(average counts in treated harborages/average counts in control harborages))×100. Large arena percent repellency values obtained are listed in Table 6 below.

TABLE 6
Large arena percent repellency values

| Compound/Blend | Large arena |
|---|---|
| No. | % repellency |
| BBC007 | 57% |
| BBC006 | 46% |
| BBB110 | 37% |
| BBB001 | 33% |
| BBB008 | 32% |
| BBB026 | 30% |
| BBB029 | 28% |
| BBB017 | 27% |
| BBB112 | 25% |
| BBB006 | 18% |
| BBB025 | 16% |
| BBB024 | 15% |
| BBB101 | 14% |
| BBB045 | 13% |
| BBB042 | 12% |
| BBB009 | 11% |
| BBB111 | 10% |

Of the compounds and blends tested, BBC007 and BBC006 proved to be the most effective. Interestingly, BBB001 and BBB045, which were both Very Strong repellents when tested according to Example 1, each yielded values less than 40% in the current assay.

### Example 4. Synergistic Blends

Many blends of the present invention were found to be very strong repellents even though they comprised compounds from weaker repellent categories. A listing of such blends is provided in Table 7. In the table, “Ind % Rep” refers to the percent repellency values obtained in Example 1 for the individual compound. “Comp” refers to compound and “Combined % Rep” refers to the percent repellency obtained for the blend of the two compounds.

TABLE 7
Repellent blends with synergistic effects

| Blend | Comp | Ind | Comp | Ind | Combined |
|---|---|---|---|---|---|
| No. | No. | % Rep | No. | % Rep | % Rep |
| BBB001 | BBC045 | 24 | BBC067 | 0 | 100 |
| BBB027 | BBC066 | 0 | BBC029 | 56 | 100 |
| BBB022 | BBC059 | 6 | BBC038 | 39 | 100 |
| BBB029 | BBC051 | 17 | BBC027 | 59 | 100 |
| BBB021 | BBC032 | 49 | BBC038 | 39 | 100 |
| BBB005 | BBC029 | 56 | BBC027 | 59 | 100 |
| BBB007 | BBC024 | 60 | BBC027 | 59 | 100 |
| BBB020 | BBC021 | 71 | BBC031 | 50 | 100 |
| BBB018 | BBC018 | 77 | BBC031 | 50 | 100 |
| BBB004 | BBC029 | 56 | BBC018 | 77 | 100 |
| BBB016 | BBC018 | 77 | BBC027 | 59 | 100 |
| BBB006 | BBC024 | 60 | BBC018 | 77 | 100 |
| BBB030 | BBC062 | 0 | BBC038 | 39 | 95 |
| BBB032 | BBC034 | 47 | BBC038 | 39 | 92 |
| BBB033 | BBC049 | 20 | BBC021 | 71 | 91 |
| BBB039 | BBC034 | 47 | BBC047 | 22 | 89 |
| BBB037 | BBC035 | 44 | BBC021 | 71 | 89 |
| BBB038 | BBC018 | 77 | BBC021 | 71 | 89 |
| BBB041 | BBC021 | 71 | BBC065 | 0 | 88 |
| BBB040 | BBC029 | 56 | BBC021 | 71 | 88 |
| BBB043 | BBC049 | 20 | BBC029 | 56 | 87 |
| BBB046 | BBC034 | 47 | BBC040 | 37 | 84 |
| BBB047 | BBC034 | 47 | BBC053 | 14 | 81 |

### Example 5. Bed Bug Trapping Assay

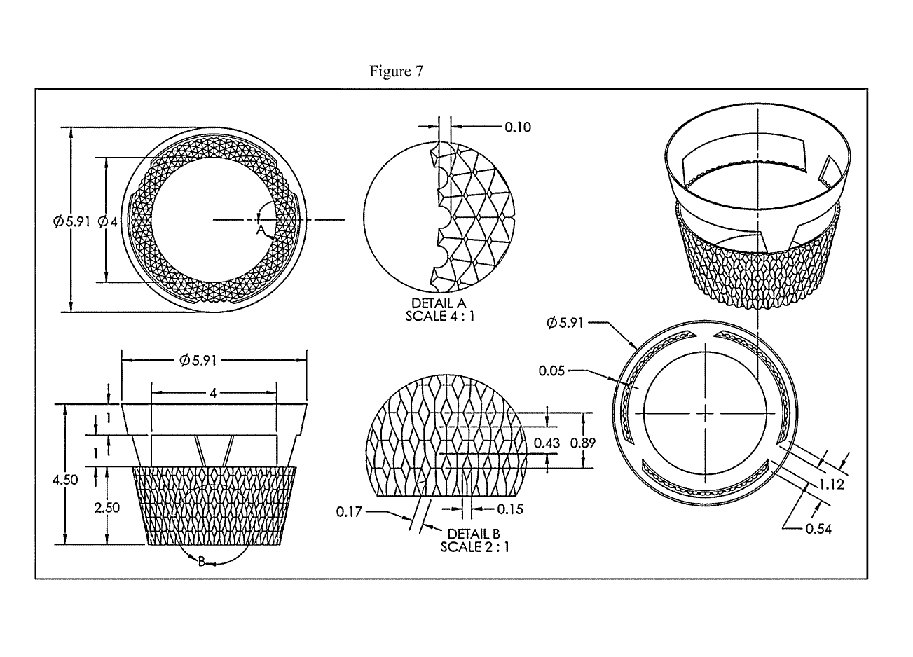

Experiments are carried out to test the ability of bed bug traps to capture bed bugs. Traps, according to the one pictured in FIG. 7, are manufactured and tested according to the protocol of Example 2 in the presence and absence of attractants.

### Example 6. Threshold Assay

Compounds and blends of the present invention were assayed for their ability to modify bed bug (Cimex lectularius) behavior using a bed bug threshold assay. Three interceptors were laid side by side and acrylic rods were stuck on to the sides with putty so that they went from interceptor to interceptor forming bridges. Paper towels sections of 6 inches by 2 inches were placed so that they hung off of the ends of the acrylic rods to form harborage for bed bugs. Next, 125 mm pieces of Whatman Filter paper treated either with the compound of interest (90 μl isopropyl alcohol+10 μl testing compound) or with control solution of 100 μl isopropyl alcohol were stuck to the top of the acrylic rods with the compound impregnated filter on one rod and control impregnated filter on the other. In the middle interceptor a mouse was placed as bait for the bed bugs. In either outside interceptors 10 bed bugs each were placed in holding dishes, allowed to equilibrate for 10 minutes then released on the harborage. Video footage at 1 second time intervals was obtained for 10 minutes then analyzed for bed bug movements.

Repellency of any given compound or blend was calculated by counting how many bed bugs traversed the acrylic rods across either the treated or the control Whatman filter paper. Percent repellency was determined by comparing the number of bed bugs which crossed the treated Whatman filter paper to the number of bed bugs which crossed the control Whatman filter paper. Results are presented in the following table.

TABLE 8
Threshold assay results

| Compound/Blend Tested | % Repellency |
|---|---|
| BBC002 | 100 |
| BBC004 | 100 |
| BBC006 | 100 |
| BBC007 | 100 |
| BBC010 | 100 |
| BBC019 | 100 |
| BBC023 | 100 |
| BBC028 | 100 |
| BBC068 | 100 |
| Citronella Oil | 100 |
| Geraniol | 100 |
| Geranium Oil | 100 |
| BBC001 | 96 |
| BBC054 | 95 |
| BBC003 | 95 |
| BBC044 | 95 |
| BBC030 | 93 |
| BBC045 | 93 |
| BBC029 | 92 |
| BBC046 | 92 |
| BBC021 | 91 |
| BBC025 | 89 |
| Lemongrass Oil | 89 |
| BBC079 | 89 |
| BBC038 | 80 |
| BBC017 | 79 |
| BBC037 | 78 |
| BBC020 | 75 |
| BBC005 | 74 |
| BBC042 | 73 |
| BBC009 | 70 |
| BBC011 | 67 |
| BBC014 | 64 |
| BBC016 | 64 |
| BBC032 | 51 |
| BBC050 | 51 |
| BBC080 | 51 |
| BBC039 | 46 |
| BBC015 | 43 |
| BBC057 | 38 |
| BBC022 | 34 |
| BBC008 | 30 |
| BBC018 | 28 |
| BBC064 | 26 |
| BBC033 | 24 |
| BBC056 | 19 |
| BBB011 | 100 |
| BBB012 | 100 |
| BBB014 | 100 |
| BBB015 | 100 |
| BBB034 | 100 |
| BBB035 | 100 |
| BBB055 | 100 |
| BBB057 | 100 |
| BBB113 | 100 |
| BBB119 | 100 |
| BBB013 | 95 |
| BBB010 | 94 |
| BBB109 | 93 |
| BBB004 | 91 |
| BBB053 | 89 |
| BBB003 | 88 |
| BBB058 | 83 |
| BBB036 | 76 |
| BBB002 | 76 |
| BBB005 | 72 |
| BBB020 | 67 |
| BBB076 | 67 |
| BBB060 | 60 |
| BBB062 | 59 |
| BBB101 | 59 |
| BBB091 | 57 |
| BBB021 | 53 |
| BBB019 | 49 |
| BBB048 | 43 |
| BBB059 | 42 |
| BBB050 | 41 |
| BBB032 | 38 |
| BBB116 | 35 |
| BBB041 | 33 |
| BBB044 | 33 |
| BBB042 | 32 |
| BBB107 | 31 |
| BBB115 | 31 |
| BBB117 | 29 |
| BBB114 | 25 |
| BBB118 | 23 |
| BBB016 | 21 |
| BBB007 | 21 |
| BBB017 | 20 |
| BBB045 | 20 |

Compounds BBC002, BBC004, BBC006, BBC007, BBC010, BBC019, BBC023, BBC028, BBC068, Citronella Oil, Geraniol, and Geranium Oil demonstrated 100% repellency as did blends BBB011, BBB012, BBB014, BBB015, BBB034, BBB035, BBB055, BBB057, BBB113, and BBB119.

1. A composition for attracting and/or repelling one or more pests to or from one or more sites, wherein said composition comprises one or more compounds selected from the group consisting of BBC001-BBC086.

2. The composition of claim 1, wherein said composition attracts bed bugs to one or more sites and comprises one or more compounds selected from the group consisting of BBC035, BBC039, BBC047, BBC060, BBC065, BBC069 and BBC070.

3. The composition of claim 1, wherein said composition attracts bed bugs to one or more sites and comprises a blend selected from the group consisting of BBB028, BBB058, BBB072, BBB078, BBB080, BBB086, BBB102-BBB107 and BBB120.

4. The composition of claim 1, wherein said one or more sites comprise a bed bug trap.

5. The composition of claim 1, wherein said composition repels bed bugs from one or more sites and comprises one or more compounds selected from the group consisting of BBC001-BBC050.

6. The composition of claim 1, wherein said composition repels bed bugs from one or more sites and comprises a blend selected from the group consisting of BBB001-BBB089.

7. The composition of claim 1, wherein said composition repels bed bugs from one or more sites and comprises a synergistic blend.

8. The composition of claim 7, wherein said synergistic blend comprises a blend selected from the group consisting of BBB001, BBB027, BBB022, BBB029, BBB021, BBB005, BBB007, BBB020, BBB018, BBB004, BBB016, BBB006, BBB030, BBB032, BBB033, BBB039, BBB037, BBB038, BBB041, BBB040, BBB043, BBB046 and BBB047.

9. The composition of claim 1, wherein said one or more sites comprise one or more areas of habitation.

10. A method of attracting and/or repelling one or more pests to or from one or more sites comprising the use of a composition according to claim 1.

11-33. (canceled)

34. A bed bug trap comprising:
a. a trap frame comprising a rim, base and trap wall,
b. a skirt layer comprising a climbing surface, and
c. an optional lure.

35. The bed bug trap of claim 34, wherein said skirt layer comprises a truncated cone shape.

36. The bed bug trap of claim 35, wherein said skirt layer starts in contact with said rim and tapers outward to form an angle between said skirt layer and said trap wall, wherein said angle is selected from the group consisting of from about 10° to about 50°.

37. (canceled)

38. The bed bug trap of claim 34, wherein said climbing surface is textured.

39. (canceled)

40. The bed bug trap of claim 34, wherein said bed bug trap comprises a plug lid.

41. The bed bug trap of claim 40, wherein said base comprises a base peg.

42. The bed bug trap of claim 41, wherein said plug lid comprises a base peg sleeve.

43. The bed bug trap of claim 42, wherein frictional force exists between said base peg and said base peg sleeve.

44. The bed bug trap of claim 43, wherein said plug lid comprises an overhang above said rim.

45-48. (canceled)

49. The bed bug trap of claim 34, wherein said trap comprises a lure comprising the composition of claim 1.

50-51. (canceled)
